(19) United States
(12) Patent Application Publication
(10) Pub. No.: US 2012/0249525 A1
(43) Pub. Date: Oct. 4, 2012

(54) DISPLAY SYSTEM

(76) Inventors: Ik-Huyn Ahn, Asan-si (KR); Bong-Im Park, Asan-si (KR); Seon-Ki Kim, Anyang-si (KR); Se-Huhn Hur, Yongin-si (KR); Jun-Pyo Lee, Asan-si (KR); Ho-Seok Son, Bupyeong-gu (KR)

(21) Appl. No.: 13/310,427

(22) Filed: Dec. 2, 2011

(30) Foreign Application Priority Data
Mar. 28, 2011 (KR) 2011-0027415

(51) Int. Cl. G06T 15/00

(52) U.S. Cl. 345/419

(57) ABSTRACT

A display system includes a display panel, a panel driving part, an image processing part, a timing control part and a light source part. The display panel displays an image. The image processing part includes a synchronization part that synchronizes a plurality of image signals respectively corresponding to a plurality of contents with each other, a scaling part that respectively scales the image signals into a plurality of image frames having a resolution of the display panel and that sequentially outputs the image frames, and an additional generating part that outputs the image frames respectively corresponding to each of the image frames received from the scaling part. The timing control part provides the image frames respectively corresponding to the contents to the panel driving part. The light source part generates a light and provides the light to the display panel.

### CROSS-REFERENCE TO RELATED APPLICATION

This application claims under 35 U.S.C. §119 priority to and the benefit of Korean Patent Application No. 2011-27415, filed on Mar. 28, 2011 in the Korean Intellectual Property Office (KIPO), the entire content of which is incorporated by reference herein.

### BACKGROUND

1. Technical Field

The present disclosure relates to a display system, and, more particularly, to a display system used for displaying multiple images corresponding to multi-contents.

2. Discussion of the Related Art

Generally, a stereoscopic image display device displays a three-dimensional (3D) stereoscopic image using the principle of binocular parallax through two eyes of a human being. For example, since two eyes of a human being are spaced apart from each other, images viewed at the different angles are inputted to the brain. Thus, the observer may watch the 3D image to recognize the stereoscopic image through the display device.

The stereoscopic image display device can be classified into a stereoscopic type with an extra spectacle and an auto-stereoscopic type without the extra spectacle. The stereoscopic type includes an analyph type, a liquid crystal shutter stereoscopic type, and the like. In the analyph type, blue and red glasses are respectively worn by two eyes of viewer. In the liquid crystal shutter stereoscopic type, a left image and a right image are temporally divided to be periodically displayed, and the viewer wears glasses which sequentially open or close a left eye liquid crystal shutter and a right eye liquid crystal shutter synchronized with the period of the left and right images.

Recently, a stereoscopic image display apparatus displaying the 3D stereoscopic image as well as a two-dimensional (2D) image has been developed according to increasing demands for the 3D stereoscopic image in the industrial field such as games, movies and the like.

### SUMMARY

Exemplary embodiments of the present invention provide a display system capable of displaying a plurality of images corresponding to multi-contents.

According to an exemplary embodiment, a display system includes a display panel configured to display an image. A panel driving part is configured to provide a data signal to the display panel. An image processing part has a synchronization part configured to synchronize a plurality of image signals respectively corresponding to a plurality of contents with each other, a scaling part configured to respectively scale the image signals into a plurality of image frames having a resolution of the display panel and to sequentially output the image frames, and an additional generating part configured to output the image frames respectively corresponding to the image frames received from the scaling part. A timing control part is configured to provide to the panel driving part the image frames respectively corresponding to the contents. A light source part is configured to generate light and to provide the light to the display panel.

when a compression image frame is received that has the image signals compressed corresponding to the contents, the synchronization part may divide the compression image frame into the image signals and synchronize the divided image signals with each other.

When the image frames having a resolution of the display panel respectively corresponding to the contents are received, the synchronization part may synchronize the received image frames with each other, and the scaling part may sequentially output the synchronized image frames.

The light source part may include a plurality of light emitting blocks arranged in an image scanning direction of the display panel, and each of the light emitting blocks may provide the light to a display block of the display panel corresponding to the light emitting block during a first period in which one image is displayed on the display block, and block the light from the display block during a second period in which images different from each other are displayed together on the display block.

The timing control part may insert a black image frame between a first image frame corresponding to a first contents and a second image frame corresponding to a second contents, and provides the first image frame, the black image frame and the second image frame to the panel driving part.

When an image signal for a left-eye and an image signal for a right-eye corresponding to one contents are received, the image processing part may output four image frames for the left-eye and four image frames for the right-eye corresponding to one contents to the timing control part.

The timing control part may sequentially output four image frames for the left-eye and four image frames for the right-eye to the panel driving part.

The timing control part may sequentially output three image frames for the left-eye, the black image frame, three image frames for the right-eye and the black image frame to the panel driving part.

When a first image signal for a left-eye, a first image signal for a right-eye, a second image signal for the left-eye and a second image signal for the right-eye corresponding to two contents are received, the image processing part may output two first image frames for the left-eye, two first image frames for the right-eye, two second image frames for the left-eye, two second image frames for the right-eye corresponding to two contents to the timing control part.

The timing control part may sequentially output two first image frames for the left-eye, two first image frames for the right-eye, two second image frames for the left-eye, and two second image frames for the right-eye to the panel driving part.

The timing control part may sequentially output a first image frame for the left-eye, the black image frame, a first image frame for the right-eye, the black image frame, a second image frame for the left-eye, the black image frame, a second image frame for the right-eye, and the black image frame to the panel driving part.

The display system may further include a first shutter glasses part, including a first left-eye shutter and a first right-eye shutter, configured to open the first left-eye shutter and to close the first right-eye shutter during a period in which a first image for the left-eye corresponding to the first image frame for the left-eye is displayed on the display panel, and configured to open the first right-eye shutter and to close the first left-eye shutter during a period in which a first image for the right-eye corresponding to the first image frame for the right-eye is displayed on the display panel, and a second shutter glasses part, including a second left-eye shutter and a second right-eye shutter, configured to open the second left-eye shutter and to close the second right-eye shutter during a period in which a second image for the left-eye corresponding to the second image frame for the left-eye is displayed on the display panel, and configured to open the second right-eye shutter and to close the second left-eye shutter during a period in which a second image for the right-eye corresponding to the second image frame for the right-eye is displayed on the display panel.

When a first image signal and a second image signal corresponding to two contents are received, the image processing part may output four first image frames and four second image frames corresponding to two contents to the timing control part.

The timing control part may sequentially output four first image frames and four second image frames to the panel driving part.

The timing control part may sequentially output three first image frames, the black image frame, three second image frames and the black image frame to the panel driving part.

The display system may further include a first shutter glasses part, including first shutters, configured to open the first shutters during a period in which a first image corresponding to the first image frame is displayed on the display panel, and to close the first shutters during a period in which a second image corresponding to the second image frame is displayed on the display panel, and a second shutter glasses part, including second shutters, configured to open the second shutters during a period in which the second image is displayed on the display panel, and to close the second shutters during a period in which the first image is displayed on the display panel.

When a first image signal, a second image signal, a third image signal and a four image signal corresponding to four contents are received, the image processing part may output two first image frames, two second image frames, two third image frames and two fourth image frames corresponding to four contents to the timing control part, the timing control part may sequentially output two first image frames, two second image frames, two third image frames and two fourth image frames to the panel driving part.

The timing control part may sequentially output a first image frame, the black image frame, a second image frame, the black image, a third image frame, the black image frame, a fourth image frame and the black image frame to the panel driving part.

The display system may further include a first shutter glasses part, including first shutters, configured to open the first shutters during a period in which a first image corresponding to the first image frame is displayed on the display panel, and to close the first shutters during a period in which second, third and fourth images respectively corresponding to the second, third and fourth image frames are displayed on the display panel, a second shutter glasses part, including second shutters, configured to open the second shutters during a period in which the second image corresponding to the second image frame is displayed on the display panel, and to close the second shutters during a period in which the first, third and fourth images respectively corresponding to the first, third and fourth image frames are displayed on the display panel, a third shutter glasses part including third shutters, configured to open the third shutters during a period in which the third image corresponding to the third image frame is displayed on the display panel, and to close the third shutters during a period in which the first, second and fourth images respectively corresponding to the first, second and fourth image frames are displayed on the display panel, and a fourth shutter glasses part including fourth shutters, configured to open the fourth shutters during a period in which the fourth image corresponding to the fourth image frame is displayed on the display panel, and to close the fourth shutters during a period in which the first, second and third images respectively corresponding to the first, second and third image frames is displayed on the display panel.

The additional generating part may use motion estimation and motion compensation (MEMC) to output the plurality of image frames.

The additional generating part may output the plurality of image frames by determining motion vectors that describe the transformation from one image to another and by applying the motion vectors to an image to synthesize the transformation from one image to a next image.

### BRIEF DESCRIPTION OF THE DRAWINGS

The above and other features and advantages of the present invention will become more apparent by describing in detailed exemplary embodiments thereof with reference to the accompanying drawings, in which:

FIG. 1 is a block diagram illustrating a display system according to an exemplary embodiment of the present invention;

FIG. 2 is a flowchart illustrating an exemplary method of displaying an image in the display system of FIG. 1;

FIG. 3 is a schematic diagram illustrating an exemplary method of processing a 3D stereoscopic image signal in the display system of FIG. 1;

FIG. 4 is a waveform diagram illustrating an exemplary method of displaying a 3D stereoscopic image in the display system of FIG. 1;

FIG. 5 is a waveform diagram illustrating another exemplary method of displaying a 3D stereoscopic image in the display system of FIG. 1;

FIG. 6 is a waveform diagram illustrating still another exemplary method of displaying a 3D stereoscopic image in the display system of FIG. 1;

FIGS. 7A and 7B are schematic diagrams illustrating an exemplary method of processing the 3D stereoscopic image signal received in various modes in the display system of FIG. 1;

FIG. 8 is a schematic diagram illustrating an exemplary method of processing a 3D stereoscopic image signal of two contents in the display system of FIG. 1;

FIG. 9 is a waveform diagram illustrating an exemplary method of displaying a 3D stereoscopic image of two contents in the display system of FIG. 1;

FIG. 10 is a waveform diagram illustrating another exemplary method of displaying a 3D stereoscopic image signal of two contents in the display system of FIG. 1;

FIGS. 11A, 11B and 11C are schematic diagrams illustrating an exemplary method of processing the 3D stereoscopic image signal of two contents received in various modes in the display system of FIG. 1;

FIG. 12 is a schematic diagram illustrating an exemplary method of processing a 2D image signal of two contents in the display system of FIG. 1;

FIG. 13 is a waveform diagram illustrating an exemplary method of displaying the 2D image of two contents in the display system of FIG. 1;

FIG. 14 is a waveform diagram illustrating another exemplary method of displaying the 2D image of two contents in the display system of FIG. 1;

FIGS. 15A and 15B are schematic diagrams illustrating an exemplary method of processing the 2D image signal of two contents received in various modes in the display system of FIG. 1;

FIG. 16 is a schematic diagram illustrating an exemplary method of processing a 2D image signal of four contents in the display system of FIG. 1;

FIG. 17 is a waveform diagram illustrating an exemplary method of displaying the 2D image of four contents in the display system of FIG. 1;

FIG. 18 is a waveform diagram illustrating another exemplary method of displaying the 2D image of four contents in the display system of FIG. 1; and

FIGS. 19A, 19B and 19C are schematic diagrams illustrating a method of processing the 2D image signal of four contents received in various modes in the display system of FIG. 1.

### DETAILED DESCRIPTION

Hereinafter, exemplary embodiments of the present invention will be explained in detail with reference to the accompanying drawings.

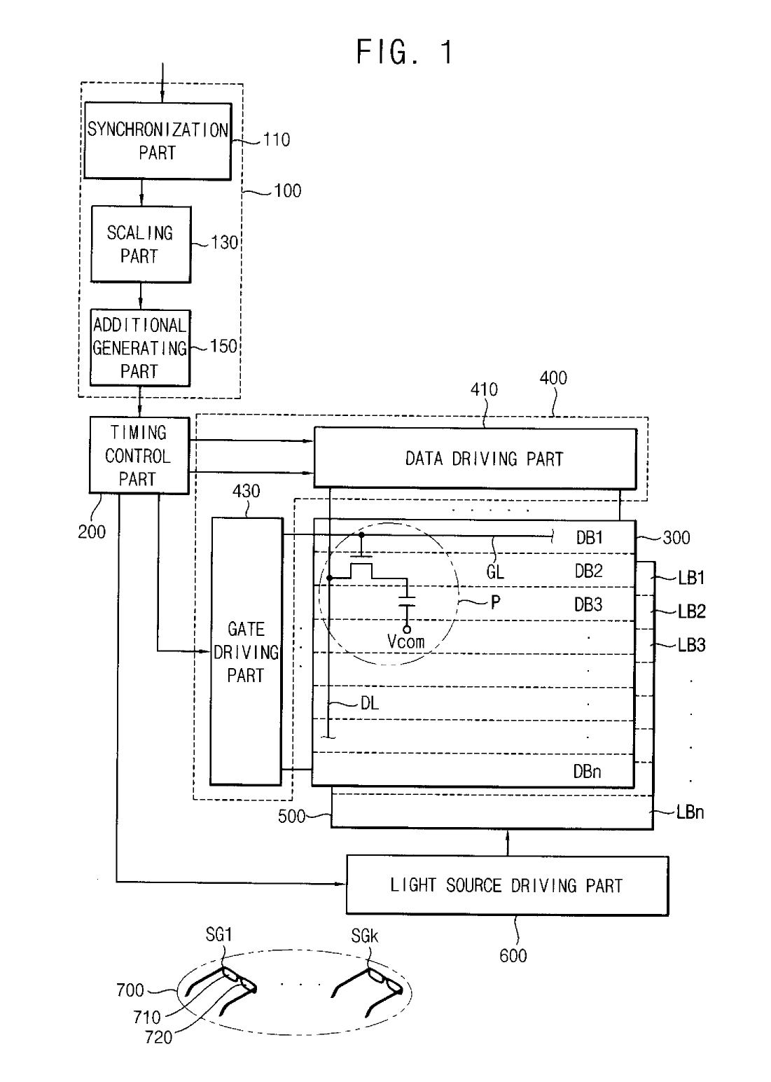

Referring now to FIG. 1, which provides a block diagram of display system according to an exemplary embodiment of the present invention, the display system includes an image processing part 100, a timing control part 200, a display panel 300, a panel driving part 400, a light source part 500, a light source driving part 600 and a shutter glasses part 700.

The image processing part 100 receives an image signal and processes the image signal according to an image mode to output a plurality of image frames. The image mode may include a three-dimensional (3D) solo mode displaying a 3D stereoscopic image corresponding to one contents, a 3D multi mode displaying a plurality of 3D stereoscopic images corresponding to a plurality of 3D contents, a two-dimensional (2D) solo mode displaying a 2D image corresponding to one contents, and a 2D multi mode displaying a plurality of 2D images corresponding to a plurality of 2D contents. The 3D multi mode may include a 3D two viewer mode displaying the 3D stereoscopic images corresponding to two 3D contents. The 2D multi mode may include a 2D two viewer mode displaying the 2D images corresponding to two 2D contents and a 2D four viewer mode displaying the 2D images corresponding to four 2D contents. The image processing part 100 includes a synchronization part 110, a scaling part 130 and an additional generating part 150. The synchronization part 110 synchronizes with each other multiple image signals received according to the image mode. The scaling part 130 scales each of the image signals provided from the synchronization part 110 into a image frame corresponding to a resolution of the display panel 400, and sequentially outputs the image frame according to the image mode. The additional generating part 150 outputs a plurality of image frames using the image frame provided from the scaling part 130. The additional generating part 150 repeats the image frame to output the plurality of image frames or processes the image frame using a motion estimation and motion compensation (MEMC) to output the plurality of image frames. The motion estimation process determines motion vectors that describe the transformation from one image to another, usually from adjacent frames in a video sequence. Motion compensation, an algorithmic technique employed in the encoding of video data for video compression, applies the motion vectors to an image to synthesize the transformation to the next image. The additional generating part 150 may output 384, 400 or 480 image frames per second. In accordance with the present exemplary embodiment, the additional generating part 150 outputs 480 image frames per second, but is not limited thereto.

The timing control part 200 provides image data of the image frame received from the image processing part 100 to the panel driving part 300. The timing control part 200 provides a timing control signal to the panel driving part 400 and controls a driving timing of the panel driving part 400.

The display panel 300 includes a plurality of data lines DL, a plurality of gate lines GL crossing the data lines DL, and a plurality of pixels P, respective pixels corresponding to each crossing of a gate line GL and a data line DL.

The panel driving part 400 includes a data driving part 410 and a gate driving part 430. The data driving part 410 converts the image data into an analog data signal, and outputs the analog data signal to a data line DL of the display panel 300. The gate driving part 430 generates a gate signal based upon the timing control signal and outputs the gate signal to a gate line GL of the display panel 300.

The light source part 500 generates light and provides the light to the display panel 300. The light source part 500 may include a plurality of light emitting blocks LB1, LB2, . . . , LBn (n being a natural number) arranged in a direction of the image scanning on the display panel 300. The light emitting blocks LB1, LB2, . . . , LBn may provide the light to a plurality of display blocks DB1, DB2, . . . , DBn of the display panel 300 respectively corresponding to the light emitting blocks LB1, LB2, . . . , LBn. For example, a first light emitting block LB1 provides light to a first display block DB1 corresponding to the first light emitting block LB1. The light source part 500 may include a plurality of light sources which may be arranged so as to provide direct-illumination or edge-illumination. The light source may be a fluorescent lamp or a light emitting diode (LED).

The light source driving part 600 generates a driving signal based upon a mode signal corresponding to the image mode provided from the timing control part 200, and provides the driving signal to the light source part 500.

The shutter glasses part 700 includes at least one of shutter glasses SG1, . . . , SGk (k being a natural number not less than 2). Each of the shutter glasses SG1 includes a left-eye shutter 710 and a right-eye shutter 720, and controls the opening and the closing of the left-eye shutter 710 and the right-eye shutter 720 based upon a shutter control signal provided from the timing control part 100 according to the image mode.

Hereinafter, an exemplary method of displaying an image according to each image mode of the present exemplary embodiment will be explained.

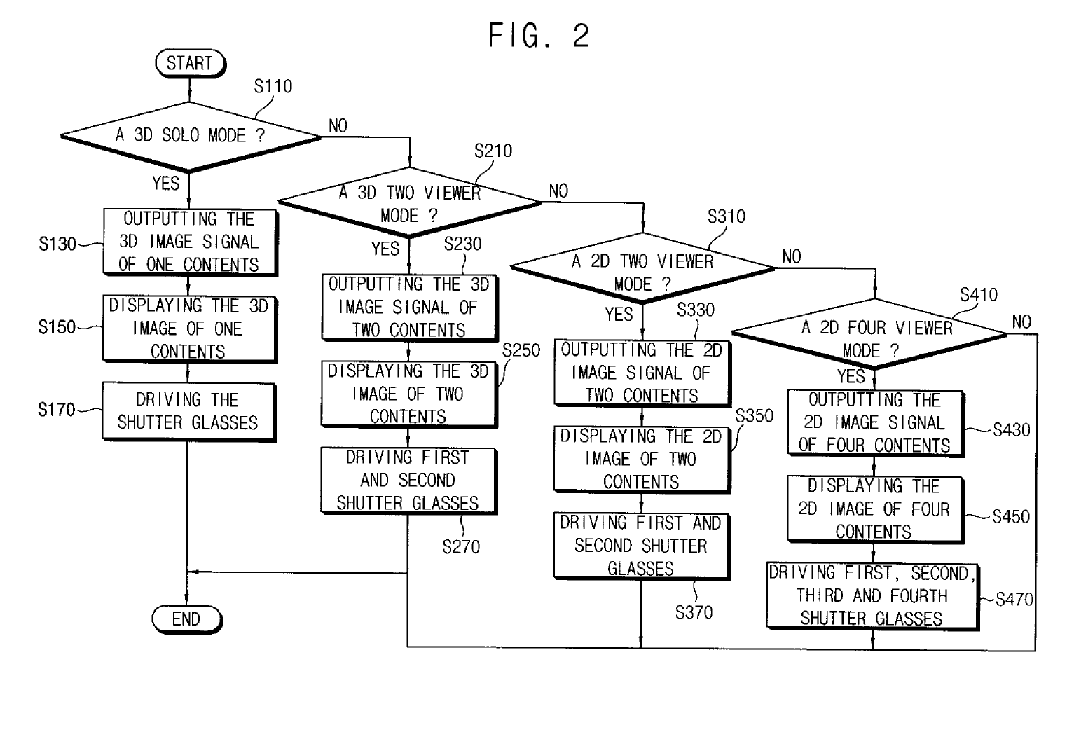

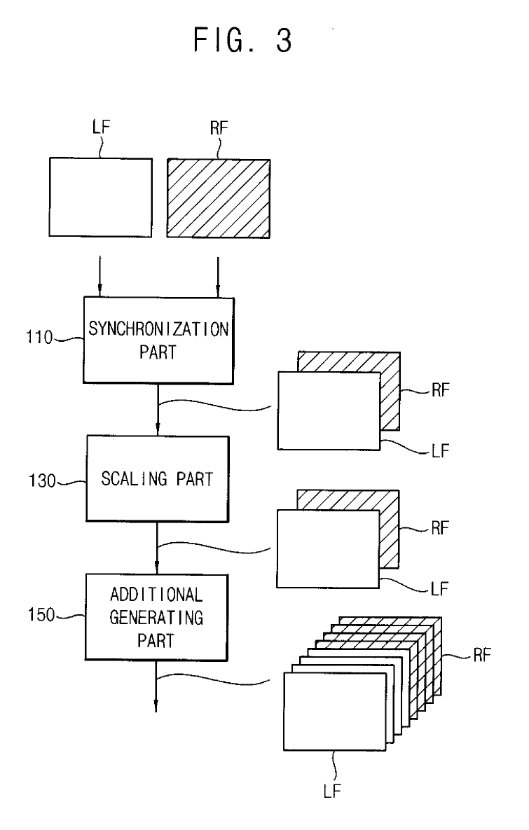

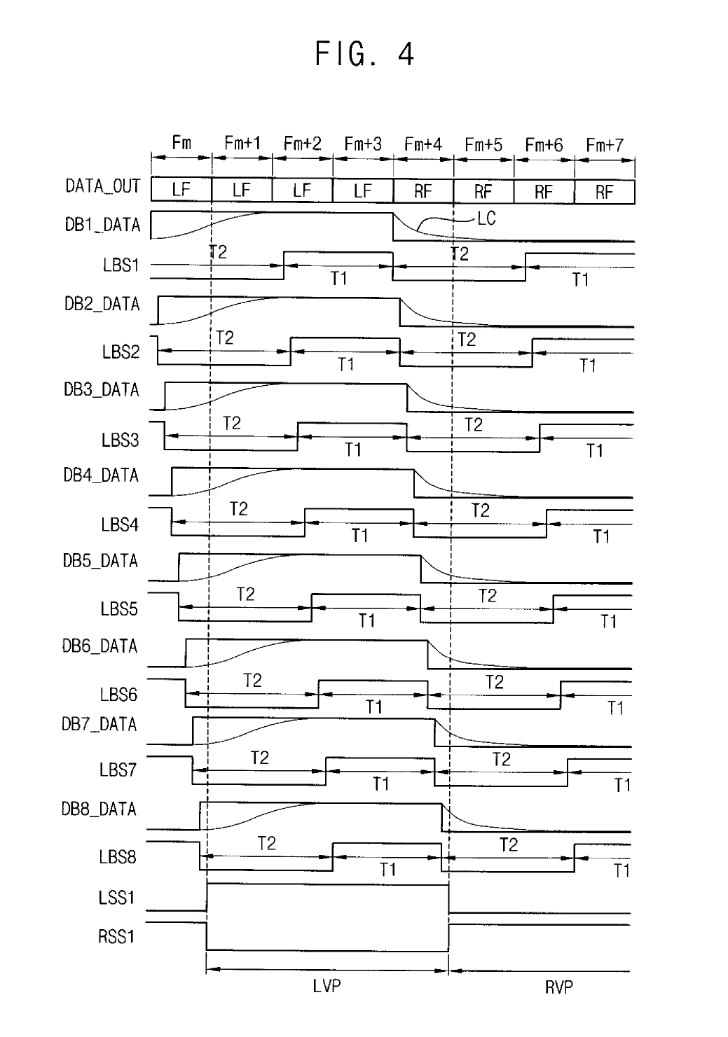

FIG. 2 is a flowchart illustrating an exemplary method of displaying an image in the display system of FIG. 1. FIG. 3 is a schematic diagram illustrating an exemplary method of processing a 3D stereoscopic image signal in the display system of FIG. 1. FIG. 4 is a waveform diagram illustrating an exemplary method of displaying a 3D stereoscopic image in the display system of FIG. 1. As shown in FIG. 4, an image frame LF for a left-eye may be referred to as an image frame of a white grayscale and an image frame RF for a right-eye may be referred to as an image frame of a black grayscale.

Referring to FIGS. 2, 3 and 4, the image processing part 100 receives an image mode signal and a 3D stereoscopic image signal corresponding to a 3D solo mode (step S110).

The image processing part 100 receives an image signal for a left-eye and an image signal for a right-eye through transmission channels different from each other. The image processing part 100 outputs the image signal for the left-eye into a plurality of image frames for the left-eye, and outputs the image signal for the right-eye frame into a plurality of image frames for the right-eye (step S130).

For example, the synchronization part 110 receives the image signal for the left-eye and the image signal for the right-eye through transmission channels different from each other. The image signal for the left-eye is an image frame LF and the image signal for the right-eye is an image frame RF, each having a data size corresponding to the resolution of the display panel 300. The synchronization part 110 synchronizes the image frame LF for the left-eye and the image frame RF for the right-eye with each other, and outputs the image frame LF for the left-eye and the image frame RF for the right-eye in synchronization with each other.

The scaling part 130 scales the image frame LF for the left-eye and the image frame RF for the right-eye to obtain the resolution of the display panel 300 and sequentially outputs the image frame LF for the left-eye and the image frame RF for the right-eye. When the received image signal is the image frame having the data size corresponding to the resolution of the display panel 300, the scaling part 130 does not scale the received image signal and sequentially outputs the image signal.

The additional generating part 150 repeats the image frame sequentially received from the scaling part 130 to output a plurality of image frames. For example, the additional generating part 150 repeats the image frame LF for the left-eye to output four image frames for the left-eye first, and repeats the image frame RF for the right-eye to output four image frames for the right-eye next.

The image processing part 100 provides four image frames for the left-eye and four image frames for the right-eye to the timing control part 200.

The timing control part 200 controls the panel driving part 400 and the light source driving part 600 based upon four image frames LF for the left-eye and four image frames RF for the right-eye to display the 3D stereoscopic image on the display panel 300 (step S150).

Referring to FIG. 4, the timing control part 200 sequentially provides four image frames LF for the left-eye and four image frames RF for the right-eye to the panel driving part 400 as DATA_OUT. The panel driving part 400 converts the image data of the image frame into the analog data signal, and outputs the analog data signal to the display panel 300 in a progressive scan mode. The panel driving part 400 may be driven at a frequency of 480 Hz.

Referring to a first display block DB1 of the display panel 300, the panel driving part 400 outputs the data signal of the image frame LF for the left-eye during an early period of each of an m-th frame Fm, an (m+1)-th frame Fm+1, an (m+2)-th frame Fm+2 and an (m+3)-th frame Fm+3 and outputs the data signal of the image frame RF for the right-eye during the early period of each of an (m+4)-th frame Fm+4, an (m+5)-th frame Fm+5, an (m+6)-th frame Fm+6 and an (m+7)-th frame Fm+7, as DB1_DATA.

The light source driving part 600 generates a first driving signal LBS1 based upon an liquid crystal (LC) response time LC, and provides the first driving signal LBS1 to a first light emitting block LB1 corresponding to a first display block DB1. For example, the first light emitting block LB1 provides the light to the first display block DB1 during a first period T1 in which the image for the left-eye or the right-eye is displayed on the first display block DB1, and blocks the light from the first display block DB1 during a second period T2 in which images for the left-eye and the right-eye are displayed together on the first display block DB1.

Referring to a fifth display block DB5 of the display panel 300, the panel driving part 400 outputs the data signal of the image frame LF for the left-eye during a middle period of each of the m-th, (m+1)-th, (m+2)-th and (m+3)-th frames Fm, Fm+1, Fm+2 and Fm+3 and outputs the data signal of the image frame RF for the right-eye during the middle period of each of the (m+4)-th, (m+5)-th, (m+6)-th and (m+7)-th frames Fm+4, Fm+5, Fm+6 and Fm+7, as DB5_DATA.

The light source driving part 600 generates a fifth driving signal LBS5 based upon the LC response time LC, and provides the fifth driving signal LBS5 to a fifth light emitting block LB5 corresponding to a fifth display block DB5. For example, the fifth light emitting block LB5 provides the light to the fifth display block DB5 during the first period T1 in which the image for the left-eye or the right-eye is display on the fifth display block DB5, and blocks the light from the fifth display block DB5 during the second period T2 in which images for the left-eye and the right-eye are displayed together on the fifth display block DB5.

Referring to an eighth display block DB8 of the display panel 300, the panel driving part 400 outputs the data signal of the image frame LF for the left-eye during a latter period of each of the m-th, (m30 1)-th, (m+2)-th and (m+3)-th frames Fm, Fm+1, Fm+2 and Fm+3, and outputs the data signal of the image frame RF for the right-eye during the latter period of each of the (m+4)-th, (m+5)-th, (m+6)-th and (m+7)-th frames Fm+4, Fm+5, Fm+6 and Fm+7, DB8_DATA.

The light source driving part 600 generates an eighth driving signal LBS8 based upon the LC response time LC, and provides the eighth driving signal LBS8 to an eighth light emitting block LB8 corresponding to an eighth display block DB8. For example, the eighth light emitting block LB8 provides the light to the eighth display block DB8 during the first period T1 in which the image for the left-eye or the right-eye is display on the eighth display block DB8, and blocks the light from the eighth display block DB8 during the second period T2 in which images for the left-eye and the right-eye are displayed together on the eighth display block DB8. As described above, the display panel 300 and the light source part 500 are driven to display the 3D stereoscopic image which includes the images for the left-eye and the right-eye.

The shutter glasses part 700 drives a shutter glasses based upon a control of the timing control part 200 according to the 3D solo mode (step S170).

The shutter glasses includes a left-eye shutter opened and closed based upon a shutter signal LSS1 for the left-eye and a right-eye shutter opened and closed based upon a shutter signal RS for the right-eye.

The left-eye shutter signal LSS1 controls the left-eye shutter 710 to be open during a left-eye view period LVP including a plurality of first periods T1 in which the light emitting blocks LB1, LB2, . . . , LB8 respectively provides the light to the display blocks DB1, DB2, . . . , DB8 displaying the image for the left-eye, and to be closed during a right-eye view period RVP including a plurality of first periods T1 in which the light emitting blocks LB1, LB2, . . . , LB8 respectively provides the light to the display blocks DB1, DB2, . . . , DB8 displaying the image for the right-eye.

The right-eye shutter signal RSS1 controls the right-eye shutter 720 to be open during the right-eye view period RVP including the first periods T1 in which the light emitting blocks LB1, LB2, . . . , LB8 respectively provides the light to the display blocks DB1, DB2, . . . , DB8 displaying the image for the right-eye, and to be closed during the left-eye view period LVP including the first periods T1 in which the light emitting blocks LB1, LB2, . . . , LB8 respectively provides the light to the display blocks DB1, DB2, . . . , DB8 displaying the image for the left-eye. The shutter glasses may be driven with 60 Hz.

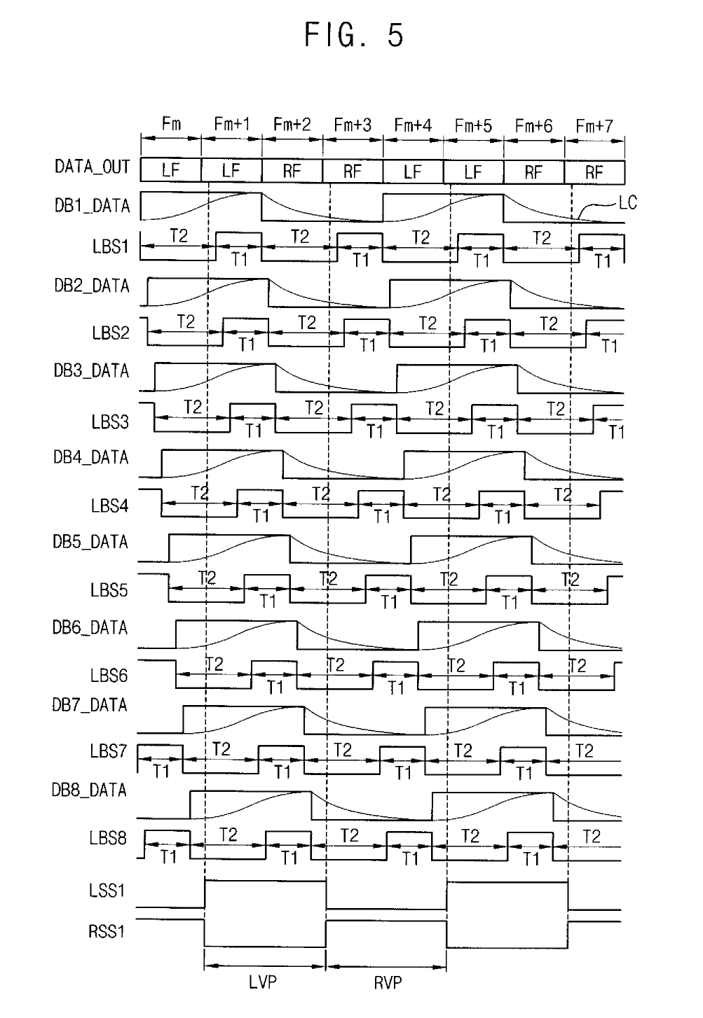

FIG. 5 is a waveform diagram illustrating another exemplary method of displaying a 3D stereoscopic image in the display system of FIG. 1. As shown in FIG. 5, an image frame LF for a left-eye may be referred to as an image frame of a white grayscale and an image frame RF for a right-eye may be referred to as an image frame of a black grayscale.

Referring to FIGS. 2, 3 and 5, the image processing part 100 receives an image mode signal and a 3D stereoscopic image signal corresponding to a 3D solo mode (step S110).

The image processing part 100 receives an image frame for a left-eye and an image frame for a right-eye frame through transmission channels different from each other to output a plurality of image frames LF for the left-eye and a plurality of image frames RF for the right-eye (step S130).

The timing control part 200 controls the panel driving part 400 and the light source driving part 600 based upon the image frames LF for the left-eye and the image frames RF for the right-eye to display the 3D stereoscopic image on the display panel 300 (step S150).

Referring to FIG. 5, the timing control part 200 sequentially provides two image frames LF for the left-eye, two image frames RF for the right-eye, two image frames LF for the left-eye, and two image frames RF for the right-eye to the panel driving part 400 DATA_OUT. The panel driving part 400 converts image data of the image frame into an analog data signal, and outputs the analog data signal to the display panel 300 in a progressive scan mode. The panel driving part 400 may be driven with 480 Hz.

Referring to a first display block DB1 of the display panel 300, the panel driving part 400 outputs the data signal of the image frame LF for the left-eye during an early period of each of an m-th frame Fm and an (m+1)-th frame Fm+1, outputs the data signal of the image frame RF for the right-eye during the early period of each of an (m+2)-th frame Fm+2 and an (m+3)-th frame Fm+3, outputs the data signal of the image frame LF for the left-eye during the early period of each of an (m+4)-th frame Fm+4 and an (m+5)-th frame Fm+5, and outputs the data signal of the image frame RF for the right-eye during the early period of each of an (m+6)-th frame Fm+6 and an (m+7)-th frame Fm+7, as DB1_DATA.

The light source driving part 600 generates a first driving signal LBS1 based upon an LC response time LC, and provides the first driving signal LBS1 to a first light emitting block LB1 corresponding to a first display block DB1. For example, the first light emitting block LB1 provides the light to the first display block DB1 during a first period T1 in which the image for the left-eye or the right-eye is displayed on the first display block DB1 and blocks the light from the first display block DB1 during a second period T2 in which the image for the left-eye and the right-eye are displayed together on the first display block DB1.

Referring to a fifth display block DB5 of the display panel 300, the panel driving part 400 outputs the data signal of the image frame LF for the left-eye during an middle period of each of the m-th and (m+1)-th frames Fm and Fm+1, outputs the data signal of the image frame RF for the right-eye during the middle period of each of the (m+2)-th and (m+3)-th frames Fm+2 and Fm+3, outputs the data signal of the image frame LF for the left-eye during the middle period of each of the (m+4)-th and (m+5)-th frames Fm+4 and Fm+5, and outputs the data signal of the image frame RF for the right-eye during the middle period of each of the (m+6)-th and (m+7)-th frames Fm+6 and Fm+7, as DB5_DATA.

The light source driving part 600 generates a fifth driving signal LBS5 based upon the LC response time LC, and provides the fifth driving signal LBS5 to a fifth light emitting block LB5 corresponding to a fifth display block DB5. For example, the fifth light emitting block LB5 provides the light to the fifth display block DB5 during the first period T1 in which the image for the left-eye or the right-eye is display on the fifth display block DB5 and blocks the light from the fifth display block DB5 during the second period T2 in which the image for the left-eye and the right-eye are displayed together on the fifth display block DB5.

Referring to an eighth display block DB8 of the display panel 300, the panel driving part 400 outputs the data signal of the image frame LF for the left-eye during a latter period of each of the m-th and (m+1)-th frames Fm and Fm+1, outputs the data signal of the image frame RF for the right-eye during the latter period of each of the (m+2)-th and (m+3)-th frames Fm+2 and Fm+3, outputs the data signal of the image frame LF for the left-eye during the latter period of each of the (m+4)-th and (m+5)-th frames Fm+4 and Fm+5, and outputs the data signal of the image frame RF for the right-eye during the latter period of each of the (m+6)-th and (m+7)-th frames Fm+6 and Fm+7, as DB8_DATA.

The light source driving part 600 generates an eighth driving signal LBS8 based upon the LC response time LC, and provides the eighth driving signal LBS8 to an eighth light emitting block LB8 corresponding to an eighth display block DB8. For example, the eighth light emitting block LB8 provides the light to the eighth display block DB8 during the first period T1 in which the image for the left-eye or the right-eye is display on the eighth display block DB8 and blocks the light from the eighth display block DB8 during the second period T2 in which the image for the left-eye and the right-eye are displayed together on the eighth display block DB8. As described above, the display panel 300 and the light source part 500 are driven to display the 3D stereoscopic image which includes the images for the left-eye and the right-eye.

The shutter glasses part 700 drives a shutter glasses based upon a control of the timing control part 200 according to the 3D solo mode (step S170).

The left-eye shutter signal LSS1 controls the left-eye shutter 710 to be open during a left-eye view period LVP including a plurality of first periods T1 in which the light emitting blocks LB1, LB2, . . . , LB8 respectively provides the light to the display blocks DB1, DB2, . . . , DB8 displaying the image for the left-eye, and to be closed during a right-eye view period RVP including a plurality of first periods T1 in which the light emitting blocks LB1, LB2, . . . , LB8 respectively provides the light to the display blocks DB1, DB2, . . . , DB8 displaying the image for the right-eye.

The right-eye shutter signal RSS1 controls the right-eye shutter 720 to be open during the right-eye view period RVP including the first periods T1 in which the light emitting blocks LB1, LB2, . . . , LB8 respectively provides the light to the display blocks DB1, DB2, . . . , DB8 displaying the image for the right-eye, and to be closed during the left-eye view period LVP including the first periods T1 in which the light emitting blocks LB1, LB2, . . . , LB8 respectively provides the light to the display blocks DB1, DB2, . . . , DB8 displaying the image for the left-eye. The shutter glasses may be driven with 60 Hz.

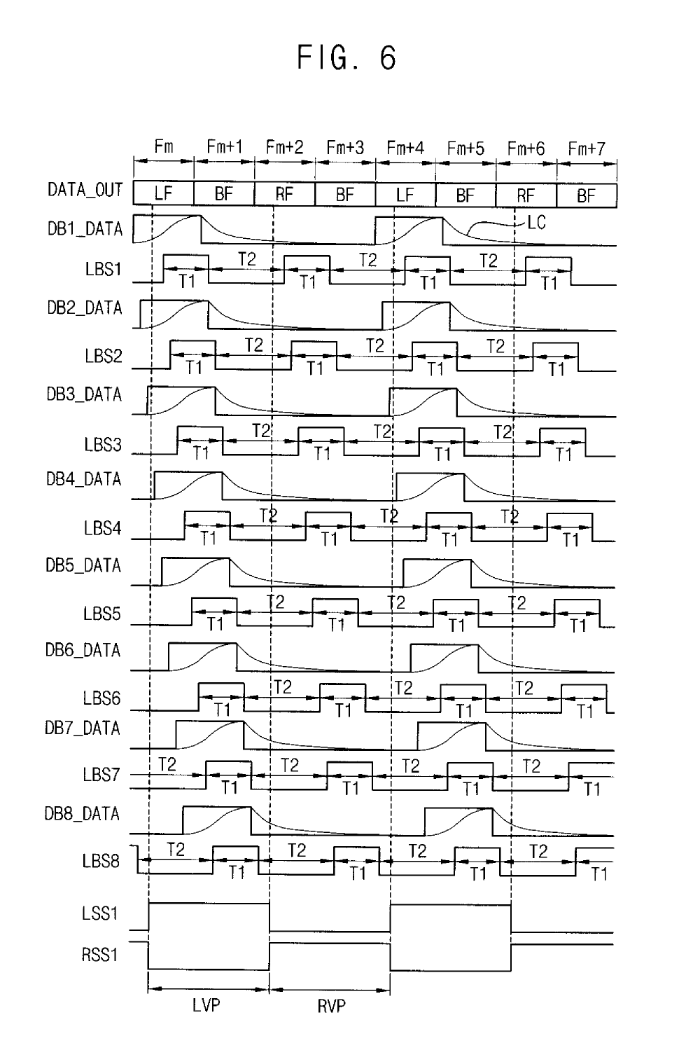

FIG. 6 is a waveform diagram illustrating still another exemplary method of displaying a 3D stereoscopic image in the display system of FIG. 1. As shown in FIG. 6, an image frame LF for a left-eye may be referred to as an image frame of a white grayscale and an image frame RF for a right-eye may be referred to as an image frame of a black grayscale.

Referring to FIGS. 2, 3 and 6, the image processing part 100 receives an image mode signal and a 3D stereoscopic image signal corresponding to a 3D solo mode (step S110).

The image processing part 100 receives an image frame LF for the left-eye and an image frame RF for the right-eye through transmission channels different from each other to output a plurality of image frames LF for the left-eye and a plurality of image frames RF for the right-eye (step S130).

The timing control part 200 controls the panel driving part 400 and the light source driving part 600 based upon the image frames LF for the left-eye and the image frames RF for the right-eye to display the 3D stereoscopic image on the display panel 300 (step S150).

Referring to FIG. 6, the timing control part 200 inserts a black image frame between the image frames LF and RF for the left-eye and the right-eye to decrease a 3D crosstalk of the images for the left-eye and the right-eye.

The timing control part 200 sequentially provides the image frame LF for the left-eye, the black image frame BF, the image frame RF for the right-eye, the black image frame BF, the image frame LF for the left-eye, the black image frame BF, the image frame RF for the right-eye and the black image frame BF to the panel driving part 400, as DATA_OUT. The panel driving part 400 converts image data of the image frame into an analog data signal, and outputs the analog data signal to the display panel 300 in a progressive scan mode. The panel driving part 400 may be driven with 480 Hz.

Referring to a first display block DB1 of the display panel 300, the panel driving part 400 outputs the image signal of the image frame LF for the left-eye during an early period of an m-th frame Fm, outputs the image signal of the black image frame BF during the early period of an (m+1)-th frame Fm+1, outputs the image signal of the image frame RF for the right-eye during the early period of an (m+2)-th frame Fm+2, outputs the image signal of the black image frame BF during the early period of an (m+3)-th frame Fm+3, outputs the image signal of the image frame LF for the left-eye during the early period of an (m+4)-th frame Fm+4, outputs the image signal of the black image frame BF during the early period of an (m+5)-th frame Fm+5, outputs the image signal of the image frame RF for the right-eye during the early period of an (m+6)-th frame Fm+6, and outputs the image signal of the black image frame BF during the early period of an (m+7)-th frame Fm+7, as DB1_DATA.

The light source driving part 600 generates a first driving signal LBS1 based upon an LC response time LC, and provides the first driving signal LBS1 to a first light emitting block LB1 corresponding to a first display block DB1. For example, the first light emitting block LB1 provides the light to the first display block DB1 during a first period T1 in which the image for the left-eye or the right-eye is displayed on the first display block DB1 and blocks the light from the first display block DB1 during a second period T2 in which the image for the left-eye and the right-eye are displayed together on the first display block DB1. As described above, the display panel 300 and the light source part 500 are driven to display the 3D stereoscopic image which includes the images for the left-eye and the right-eye.

The shutter glasses part 700 drives a shutter glasses based upon a control of the timing control part 200 according to the 3D solo mode (step S170). A first left-eye shutter signal LSS1 and a first right-eye shutter signal RSS1 driving the shutter glasses may be driven with 120 Hz.

Each of the first left-eye shutter signal LSS1 and the first right-eye shutter signal RSS1 may have a delay difference with respect to each of the first left-eye shutter signal LSS1 and the first right-eye shutter signal RSS1 described in FIG. 5 due to the black image frame BF.

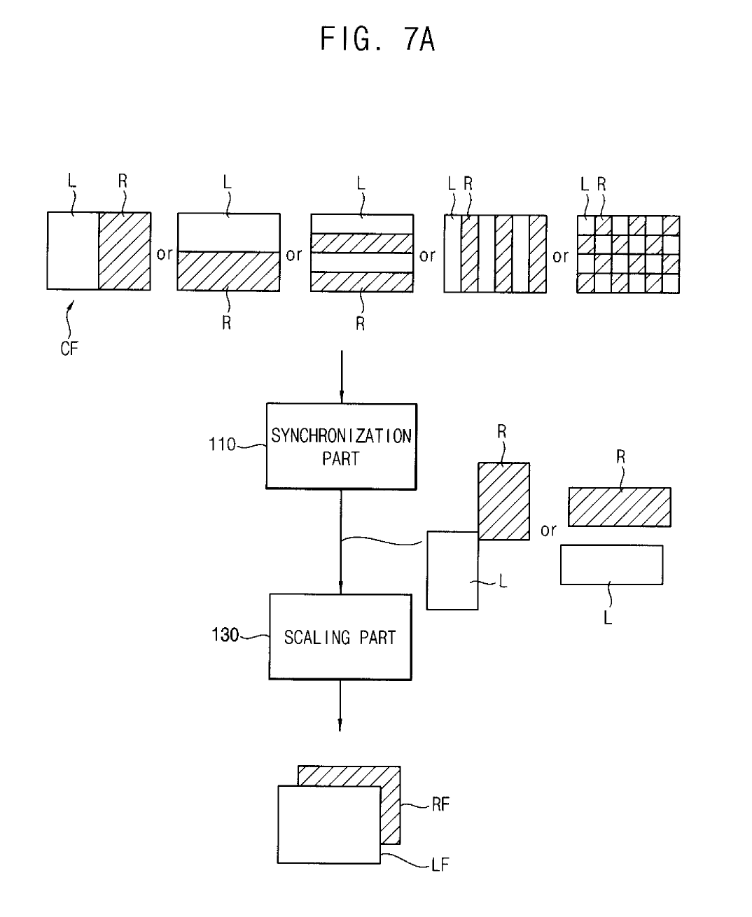

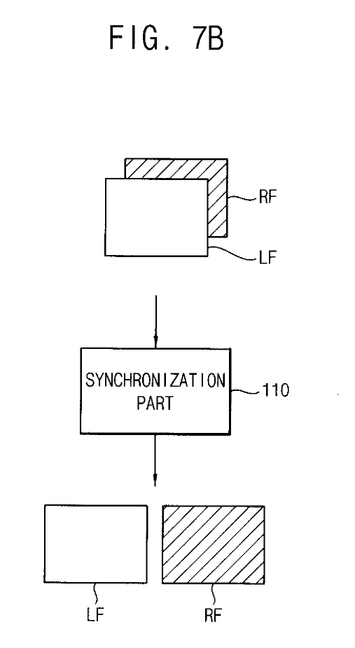

FIGS. 7A and 7B are schematic diagrams illustrating an exemplary method of processing the 3D stereoscopic image signal received in various modes in the display system of FIG. 1.

Referring to FIGS. 1 and 7A, the synchronization part 110 receives a compression image frame CF compressed an image signal L for a left-eye and an image signal R for a right-eye through a transmission channel. The compression image frame CF may be compressed by a side-by-side mode, a top-bottom mode, a horizontal interleave mode, a vertical interleave mode, a checkerboard mode, etc.

As shown in FIG. 7A, a compression image frame CF of the side-by-side mode is an image frame including the compressed image signals L and R for the left-eye and the right-eye arranged from side to side. A compression image frame CF of the top-bottom mode is an image frame including the compressed image signals L and R for the left-eye and the right-eye arranged from up and down. A compression image frame CF of the horizontal interleave mode is an image frame including the compressed image signals L and R for the left-eye and the right-eye alternately arranged in a horizontal direction. A compression image frame CF of the vertical interleave mode is an image frame including the compressed image signals L and R for the left-eye and the right-eye alternately arranged in a vertical direction. A compression image frame CF of the checkerboard mode is an image frame including the compressed image signals L and R for the left-eye and the right-eye alternately arranged as a checkerboard shape.

The synchronization part 110 divides the compression image frame CF into the image signal L for the left-eye and the image signal R for the right-eye, and outputs the image signals L and R and the left-eye and the right-eye in synchronization with each other.

The scaling part 130 scales the image signal L for the left-eye and the image signal R for the right-eye into an image frame LF for the left-eye and an image frame RF for the right-eye corresponding to a resolution of the display panel 300, respectively. The scaling part 130 sequentially outputs the image frame LF for the left-eye and the image frame RF for the right-eye.

The additional generating part 150 repeats the image frame LF for the left-eye and the image frame RF for the right-eye to output a plurality of image frames LF for the left-eye and a plurality of image frames RF for the right-eye, respectively. The additional generating part 150 may output the received image frames into a plurality of image frames using an MEMC mode, respectively.

A method of driving the timing control part 200, the panel driving part 400, the light source driving part 600 and the shutter glasses part 700 may be substantially the same as the method previously described referring to FIGS. 2 to 6 and any further repetitive explanation concerning the above elements will be omitted.

Referring to FIGS. 1 and 7B, the synchronization part 110 receives an image frame LF for the left-eye and an image frame RF for the right-eye through a transmission channel. The synchronization part 110 outputs the image frames LF and RF for the left-eye and the right-eye in synchronization with each other to the scaling part 130. The scaling part 130 scales the image frames LF and RF for the left-eye and the right-eye into image frames LF and RF for the left-eye and the right-eye corresponding to a resolution of the display panel 300, respectively, and sequentially outputs the image frames LF and RF for the left-eye and the right-eye to the additional generating part 150. The additional generating part 150 repeats the image frame LF for the left-eye and the image frame RF for the right-eye to output a plurality of image frames LF for the left-eye and a plurality of image frames RF for the right-eye, respectively. The additional generating part 150 may output the received image frames into a plurality of image frames using an MEMC mode, respectively.

A method of driving the timing control part 200, the panel driving part 400, the light source driving part 600 and the shutter glasses part 700 may be substantially the same as the method previously described referring to FIGS. 2 to 6 and any further repetitive explanation concerning the above elements will be omitted.

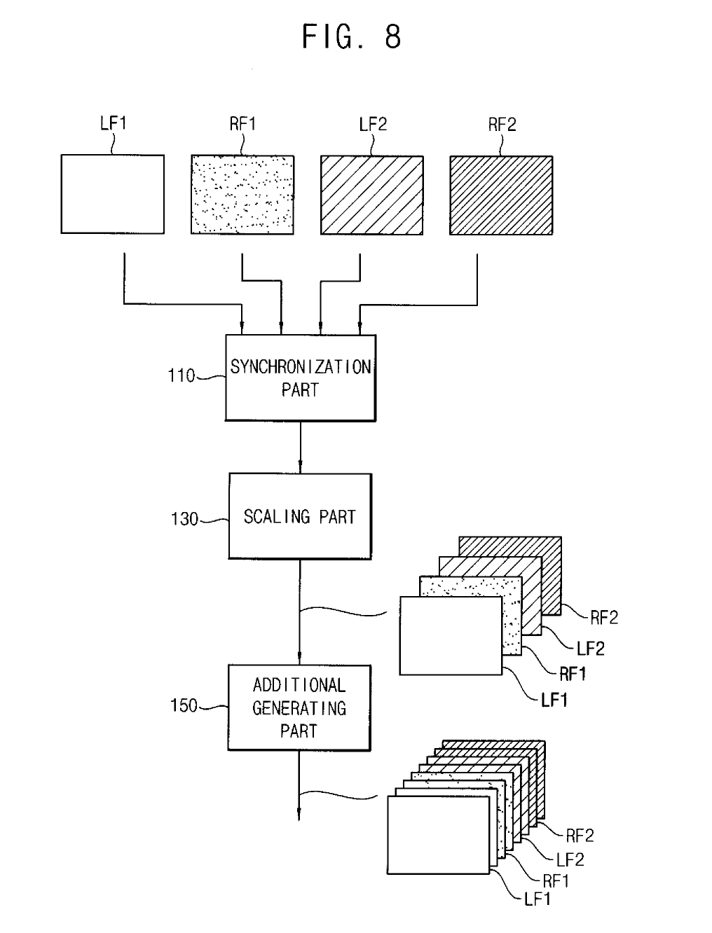

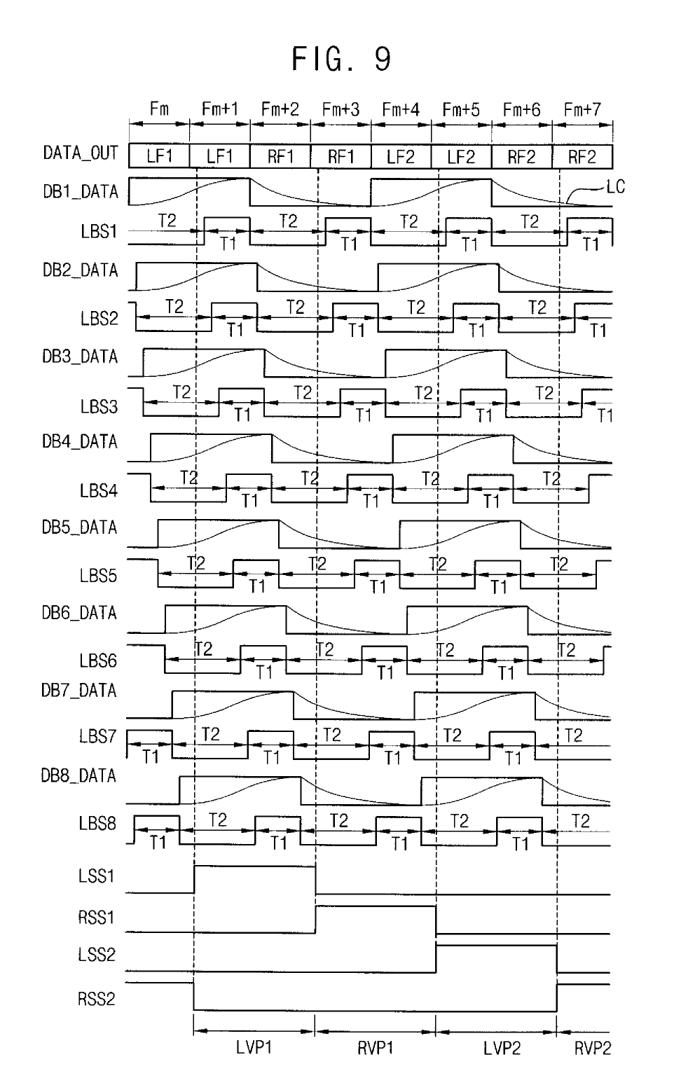

FIG. 8 is a schematic diagram illustrating an exemplary method of processing a 3D stereoscopic image signal of two contents in the display system of FIG. 1. FIG. 9 is a waveform diagram illustrating an exemplary method of displaying a 3D stereoscopic image of two contents in the display system of FIG. 1. As shown in FIG. 9, an image frame LF for a left-eye may be referred to as an image frame of a white grayscale and an image frame RF for a right-eye may be referred to as an image frame of a black grayscale.

Referring to FIGS. 2, 8 and 9, the image processing part 100 receives an image mode signal and a 3D stereoscopic image signal corresponding to a 3D two viewer mode (step S210).

The image processing part 100 receives a first image frame LF1 for a left-eye, a first image frame RF1 for a right-eye, a second image frame LF2 for the left-eye and a second image frame RF2 for the right-eye through transmission channels different from each other, and outputs a plurality of first image frames LF1 for a left-eye, a plurality of first image frames RF1 for a right-eye, a plurality of second image frames LF2 for the left-eye and a plurality of second image frames RF2 for the right-eye (step S230).

For example, the synchronization part 110 receives the first image frame LF1 for the left-eye, the first image frame RF1 for the right-eye, the second image frame LF2 for the left-eye and the second image frame RF2 for the right-eye through transmission channels different from each other. The synchronization part 110 outputs the first image frame LF1 for the left-eye, the first image frame RF1 for the right-eye, the second image frame LF2 for the left-eye and the second image frame RF2 for the right-eye in synchronization with each other.

The scaling part 130 scales each of the first image frame LF1 for the left-eye, the first image frame RF1 for the right-eye, the second image frame LF2 for the left-eye into a resolution of the display panel 300. The scaling part 130 sequentially outputs the first image frame LF1 for the left-eye, the first image frame RF1 for the right-eye, the second image frame LF2 for the left-eye, and the second image frame RF2 for the right-eye which are scaled.

The additional generating part 150 outputs a plurality of image frames using the image frame sequentially provided from the scaling part 130. For example, the additional generating part 150 repeats the first image frame LF1 for the left-eye to output two first image frames LF1 for the left-eye, repeats the first image frame RF1 for the right-eye to output two first image frames RF1 for the right-eye, the second image frame LF2 for the left-eye to output two second image frames LF2 for the left-eye, and repeats the second image frame RF2 for the right-eye to output two second image frames RF2 for the right-eye.

The image processing part 100 sequentially provides two first image frames LF1 for the left-eye, two first image frames RF1 for the right-eye, two second image frames LF2 for the left-eye, and two second image frames RF2 for the right-eye to the timing control part 200.

The timing control part 200 controls the panel driving part 400 and the light source driving part 600 to display the 3D stereoscopic image of two contents on the display panel 300 (step S250).

Referring to FIG. 9, the timing control part 200 sequentially provides two first image frames LF1 for the left-eye, two first image frames RF1 for the right-eye, two second image frames LF2 for the left-eye, and two second image frames RF2 for the right-eye to the panel driving part 400, as DATA_OUT. The panel driving part 400 converts image data of the image frame into an analog data signal, and outputs the analog data signal to the display panel 300 in a progressive scan mode. The panel driving part 400 may be driven with 480 Hz.

Referring to a first display block DB1 of the display panel 300, the panel driving part 400 outputs the data signal of the first image frame LF1 for the left-eye during an early period of each of an m-th frame Fm and an (m+1)-th frame Fm+1, outputs the data signal of the first image frame RF1 for the right-eye during the early period of each of an (m+2)-th frame Fm+2 and an (m+3)-th frame Fm+3, outputs the data signal of the second image frame LF2 for the left-eye during the early period of each of an (m+4)-th frame Fm+4 and an (m+5)-th frame Fm+5, and outputs the data signal of the second image frame RF2 for the right-eye during the early period of each of an (m+6)-th frame Fm+6 and an (m+7)-th frame Fm+7, DB1_DATA.

The light source driving part 600 generates a first driving signal LBS1 based upon an LC response time LC, and provides the first driving signal LBS1 to a first light emitting block LB1 corresponding to a first display block DB1. For example, the first light emitting block LB1 provides the light to the first display block DB1 during a first period T1 in which the image for the left-eye or the right-eye is displayed on the first display block DB1, and blocks the light from the first display block DB1 during a second period T2 in which the image for the left-eye and the right-eye are displayed together on the first display block DB1.

As described above, second to eighth display blocks DB2˜DB8 of the display panel 300 display an image respectively corresponding to the first image frame LF1 for the left-eye, the first image frame RF1 for the right-eye, the second image frame LF2 for the left-eye and the second image frame RF2 for the right-eye. Each of second to eighth light emitting blocks LB2˜LB8 provides the light to the corresponded display block during a first period T1 in which the image for the left-eye or the right-eye is displayed on the corresponded display block, and blocks the light from the corresponded display block during a second T2 in which the images for the left-eye and the right-eye are displayed together on the corresponded display block. As described above, the display panel 300 and the light source part 500 are driven to display the 3D stereoscopic image of two contents, a first image for the left-eye, a first image for the right-eye, a second image for the left-eye, and a second image for the right-eye.

The shutter glasses part 700 drives a first shutter glasses and a second shutter glasses based upon a control of the timing control part 200 according to the 3D two viewer mode (step S270).

The first shutter glasses includes a first left-eye shutter opened and closed based upon a first shutter signal LSS1 for the left-eye and a first right-eye shutter opened and closed based upon a first shutter signal RSS1 for the right-eye, and the second shutter glasses includes a second left-eye shutter opened and closed based upon a second shutter signal LSS2 for the left-eye and a second right-eye shutter opened and closed based upon a second shutter signal RSS2 for the right-eye.

The first left-eye shutter signal LSS1 controls the first left-eye shutter to be open during a first left-eye view period LVP1 including a plurality of first periods T1 in which the light emitting blocks LB1, LB2, . . . , LB8 respectively provides the light to the display blocks DB1, DB2, . . . , DB8 displaying a first image for the left-eye, and to be closed during a first right-eye view period RVP1 including a plurality of first periods T1 in which the light emitting blocks LB1, LB2, . . . , LB8 respectively provides the light to the display blocks DB1, DB2, . . . , DB8 displaying the image for the right-eye.

The first right-eye shutter signal RSS1 controls the first right-eye shutter to be open during the first right-eye view period RVP1 including the first periods T1 in which the light emitting blocks LB1, LB2, . . . , LB8 respectively provides the light to the display blocks DB1, DB2, . . . , DB8 displaying a first image for the right-eye, and to be closed during the first left-eye view period LVP1 including the first periods T1 in which the light emitting blocks LB1, LB2, . . . , LB8 respectively provides the light to the display blocks DB1, DB2, . . . , DB8 displaying the first image for the left-eye.

The second left-eye shutter signal LSS2 controls the second left-eye shutter to be open during a second left-eye view period LVP2 including a plurality of first periods T1 in which the light emitting blocks LB1, LB2, . . . , LB8 respectively provides the light to the display blocks DB1, DB2, . . . , DB8 displaying a second image for the left-eye, and to be closed during a second right-eye view period RVP2 including a plurality of first periods T1 in which the light emitting blocks LB1, LB2, . . . , LB8 respectively provides the light to the display blocks DB1, DB2, . . . , DB8 displaying the second image for the right-eye.

The second right-eye shutter signal RSS2 controls the second right-eye shutter to be open during the second right-eye view period RVP2 including the first periods T1 in which the light emitting blocks LB1, LB2, . . . , LB8 respectively provides the light to the display blocks DB1, DB2, . . . , DB8 displaying a second image for the right-eye, and to be closed during the second left-eye view period LVP2 including the first periods T1 in which the light emitting blocks LB1, LB2, . . . , LB8 respectively provides the light to the display blocks DB1, DB2, . . . , DB8 displaying the second image for the left-eye.

Accordingly, two viewers may view the 3D stereoscopic images different from each other, respectively.

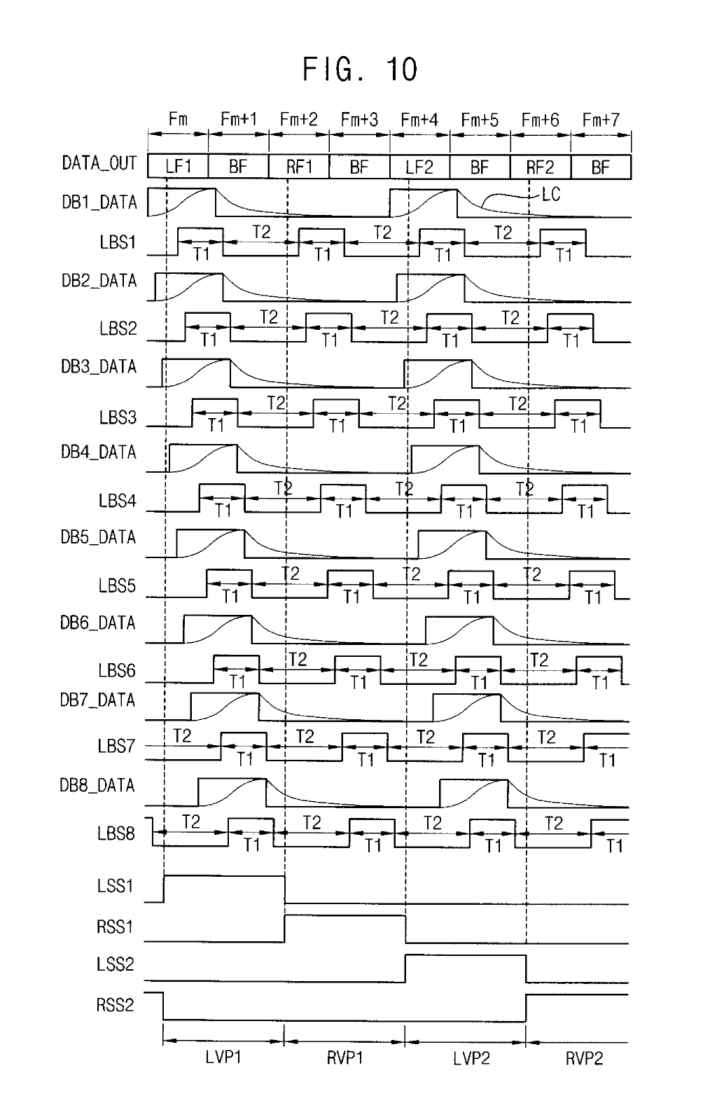

FIG. 10 is a waveform diagram illustrating another exemplary method of displaying a 3D stereoscopic image signal of two contents in the display system of FIG. 1. As shown in FIG. 10, an image frame LF for a left-eye may be referred to as an image frame of a white grayscale and an image frame RF for a right-eye may be referred to as an image frame of a black grayscale.

Referring to FIGS. 2, 8 and 10, the image processing part 100 receives an image mode signal and a 3D stereoscopic image signal corresponding to a 3D two viewer mode (step S210).

The image processing part 100 receives a first image frame LF1 for a left-eye, a first image frame RF1 for a right-eye, a second image frame LF2 for the left-eye and a second image frame RF2 for the right-eye through transmission channels different from each other, and outputs two first image frames LF1 for a left-eye, two first image frames RF1 for a right-eye, two second image frames LF2 for the left-eye and two second image frames RF2 for the right-eye (step S230).

The timing control part 200 controls the panel driving part 400 and the light source driving part 600 based upon two first image frames LF1 for the left-eye, two first image frames RF1 for the right-eye, two second image frames LF2 for the left-eye, two second image frames RF2 for the right-eye to display the 3D stereoscopic image of two contents on the display panel 300 (step S250).

Referring to FIG. 10, the timing control part 200 inserts a black image frame between the image frames for the left-eye and the right-eye to decrease a 3D crosstalk of the images for the left-eye and the right-eye.

The timing control part 200 sequentially provides the first image frame LF1 for the left-eye, the black image frame BF, the first image frame RF1 for the right-eye, the black image frame BF, the second image frame LF2 for the left-eye, the black image frame BF, the second image frame RF2 for the right-eye and the black image frame BF to the panel driving part 400 DATA_OUT. The panel driving part 400 converts the image data of the image frame into the data signal of the analogue type, and outputs the data signal to the display panel 300 in a progressive scan mode. The panel driving part 400 may be driven with 480 Hz.

Referring to a first display block DB1 of the display panel 300, the panel driving part 400 outputs the image signal of the first image frame LF1 for the left-eye during an early period of an m-th frame Fm, outputs the image signal of the black image frame BF during the early period of an (m+1)-th frame Fm+1, outputs the image signal of the first image frame RF1 for the right-eye during the early period of an (m+2)-th frame Fm+2, outputs the image signal of the black image frame BF during the early period of an (m+3)-th frame Fm+3, outputs the image signal of the second image frame LF2 for the left-eye during the early period of an (m+4)-th frame Fm+4, outputs the image signal of the black image frame BF during the early period of an (m+5)-th frame Fm+5, outputs the image signal of the second image frame RF2 for the right-eye during the early period of an (m+6)-th frame Fm+6, and outputs the image signal of the black image frame BF during the early period of an (m+7)-th frame Fm+7, as DB1_DATA.

The light source driving part 600 generates a first driving signal LBS1 based upon an LC response time LC, and provides the first driving signal LBS1 to a first light emitting block LB1 corresponding to a first display block DB1. For example, the first light emitting block LB1 provides the light to the first display block DB1 during a first period T1 in which a first image for the left-eye, a first image for the right-eye, a second image for the left-eye or a second image for the right-eye, is displayed on the first display block DB1, and blocks the light from the first display block DB1 during a second period T2 in which the image for the left-eye and the right-eye are displayed together on the first display block DB1.

As described above, the display panel 300 and the light source part 500 are driven to display the 3D stereoscopic image of two contents that includes first images for the left-eye and the right-eye and second images for the left-eye and the right-eye.

The shutter glasses part 700 drives a first shutter glasses and a second shutter glasses based upon a control of the timing control part 200 according to the 3D two viewer mode (step S270).

The first shutter glasses includes a first left-eye shutter and a first right-eye shutter opened and closed based upon first shutter signals LSS1 and RSS1 for the left-eye and the right-eye, and the second shutter glasses includes a second left-eye shutter and a second right-eye shutter opened and closed based upon second shutter signals LSS2 and RSS2 for the left-eye and the right-eye.

A method of driving the first and second shutter glasses using the first and second shutter signals LSS1, RSS1, LSS2 and RSS2 for the left-eye and the right-eye according to the present exemplary embodiment may be substantially the same as the method described referring to FIG. 9. However, each of the first and second shutter signals LSS1, RSS1, LSS2 and RSS2 for the left-eye and the right-eye according to the present exemplary embodiment may have a delay difference with respect to each of the first and second shutter signals LSS1, RSS1, LSS2 and RSS2 for the left-eye and the right-eye described in FIG. 9 due to the black image frame BF.

As described above, two viewers may view the 3D stereoscopic images different from each other, respectively. For example, images for viewing a display, such as in a motion picture theater, may be different based upon whether the viewer is directly in front of the display or a more toward a periphery of the display.

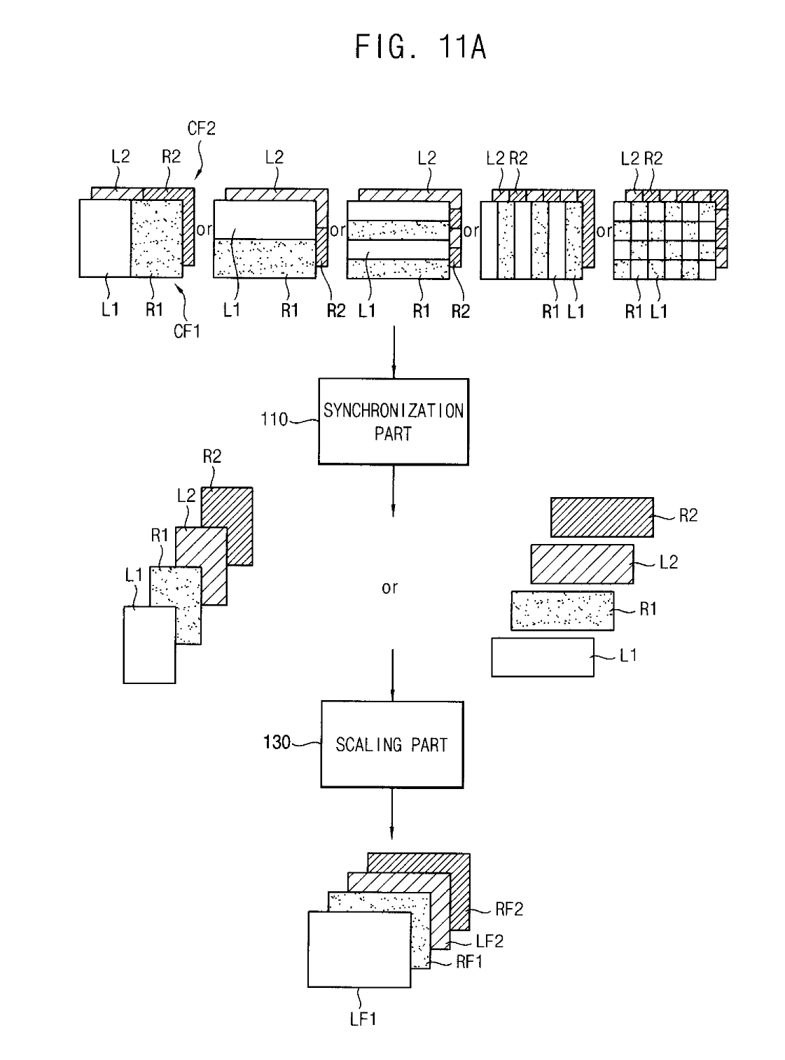

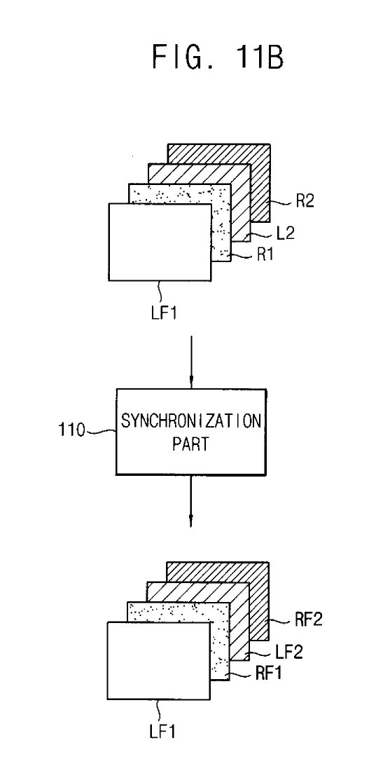

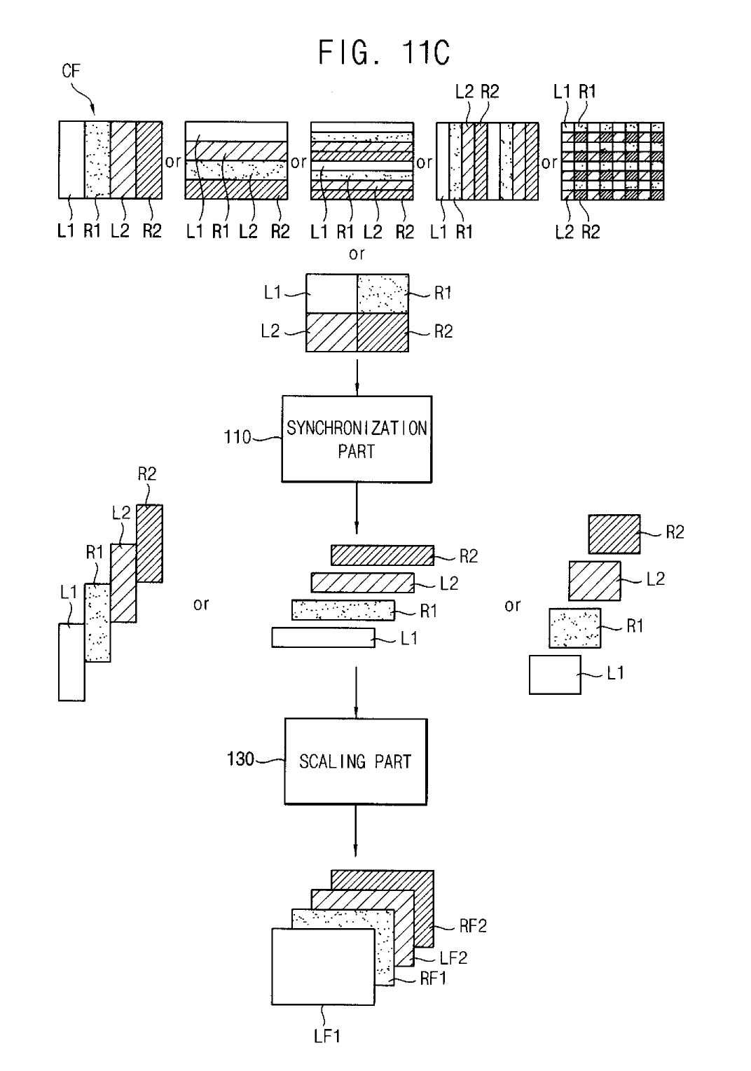

FIGS. 11A, 11B and 11C are schematic diagrams illustrating an exemplary method of processing the 3D stereoscopic image signal of two contents received in various modes in the display system of FIG. 1.

Referring to FIGS. 1 and 11A, the synchronization part 110 receives a first compression image frame CF1 and a second compression image frame CF2 through the same transmission channel. The first compression image frame CF1 includes a first image signal L1 for the left-eye and a first image signal R1 for the right-eye, each of which is compressed by ½. The second compression image frame CF2 includes a second image signal L2 for the left-eye and a second image signal R2 for the right-eye, each of which is compressed by ½. The first and second compression image frames CF1 and CF2 may be compressed by a side-by-side mode, a top-bottom mode, a horizontal interleave mode, a vertical interleave mode, a checkerboard mode, etc.

The synchronization part 110 divides the first and second compression image frame CF1 and CF2 into the first image signal L1 for the left-eye, the first image signal R1 for the right-eye, the second image signal L2 for the left-eye, the second image signal R2 for the right-eye, and outputs the image signals L1, R1, L2 and R2 in synchronization with each other.

The scaling part 130 scales the first image signal L1 for the left-eye, the first image signal R1 for the right-eye, the second image signal L2 for the left-eye, the second image signal R2 for the right-eye into a first image frame LF1 for the left-eye, a first image frame RF1 for the right-eye, a second image frame LF2 for the left-eye, and a second image frame RF2 for the right-eye corresponding to a resolution of the display panel 300. The scaling part 130 sequentially outputs the first image frame LF1 for the left-eye, the first image frame RF1 for the right-eye, the second image frame LF2 for the left-eye and the second image frame RF2 for the right-eye.

The additional generating part 150 repeats the first image frame LF1 for the left-eye, the first image frame RF1 for the right-eye, the second image frame LF2 for the left-eye, and the second image frame RF2 for the right-eye to output a plurality of first image frames LF1 and LF1 for the left-eye, a plurality of first image frames RF1 and RF1 for the right-eye, a plurality of second image frames LF2 and LF2 for the left-eye and the second image frames RF2 and RF2 for the right-eye, respectively. The additional generating part 150 may output the received image frames LF1, RF1, LF2 and RF2 into a plurality of image frames using an MEMC mode, respectively.

A method of driving the timing control part 200, the panel driving part 400, the light source driving part 600 and the shutter glasses part 700 may be substantially the same as the method previously described referring to FIGS. 2 and 8 to 10 and any further repetitive explanation concerning the above elements will be omitted.

Referring to FIGS. 1 and 11B, the synchronization part 110 receives a first image frame LF1 for the left-eye, a first image frame RF1 for the right-eye, a second image frame LF2 for the left-eye and a second image frame RF2 for the right-eye through the same transmission channel. The synchronization part 110 outputs the first image frame LF1 for the left-eye, the first image frame RF1 for the right-eye, the second image frame LF2 for the left-eye and the second image frame RF2 for the right-eye in synchronization with each other to the scaling part 130. The scaling part 130 scales the first image frame LF1 for the left-eye, the first image frame RF1 for the right-eye, the second image frame LF2 for the left-eye and the second image frame RF2 for the right-eye, and sequentially output the image frames LF1, RF1, LF2 and RF2 to the additional generating part 150. The additional generating part 150 repeats the first image frame LF1 for the left-eye, the first image frame RF1 for the right-eye, the second image frame LF2 for the left-eye and the second image frame RF2 for the right-eye to output a plurality of first image frames LF1 and LF1 for the left-eye, a plurality of first image frames RF1 and RF1 for the right-eye, a plurality of second image frames LF2 and LF2 for the left-eye and the second image frames RF2 and RF2 for the right-eye, respectively. The additional generating part 150 may output the received image frames LF1, RF1, LF2 and RF2 into a plurality of image frames using an MEMC mode, respectively.

A method of driving the timing control part 200, the panel driving part 400, the light source driving part 600 and the shutter glasses part 700 may be substantially the same as the method previously described referring to FIGS. 2 and 8 to 10 and any further repetitive explanation concerning the above elements will be omitted.

Referring to FIGS. 1 and 11C, the synchronization part 110 receives a compression image frame CF through a same transmission channel. The compression image frame CF includes a first image signal L1 for the left-eye, a first image signal R1 for the right-eye, a second image signal L2 for the left-eye, a second image signal R2 for the right-eye, each of which is compressed by ¼. The compression image frame CF may be compressed by a side-by-side mode, a top-bottom mode, a horizontal interleave mode, a vertical interleave mode, a checkerboard mode, etc.

The synchronization part 110 divides the compression image frame CF into the first image signal L1 for the left-eye, the first image signal R1 for the right-eye, the second image signal L2 for the left-eye, the second image signal R2 for the right-eye, and outputs the image signals L1, L2, R1 and R2 in synchronization with each other.

Using the scaling part 130 and the additional generating part 150, a plurality of first image frames LF1 and LF1 for the left-eye, a plurality of first image frames RF1 and RF1 for the right-eye, a plurality of second image frames LF2 and LF2 for the left-eye and the second image frames RF2 and RF2 for the right-eye, are sequentially outputted.

A method of driving the timing control part 200, the panel driving part 400, the light source driving part 600 and the shutter glasses part 700 may be substantially the same as the method previously described referring to FIGS. 2 and 8 to 10 and any further repetitive explanation concerning the above elements will be omitted.

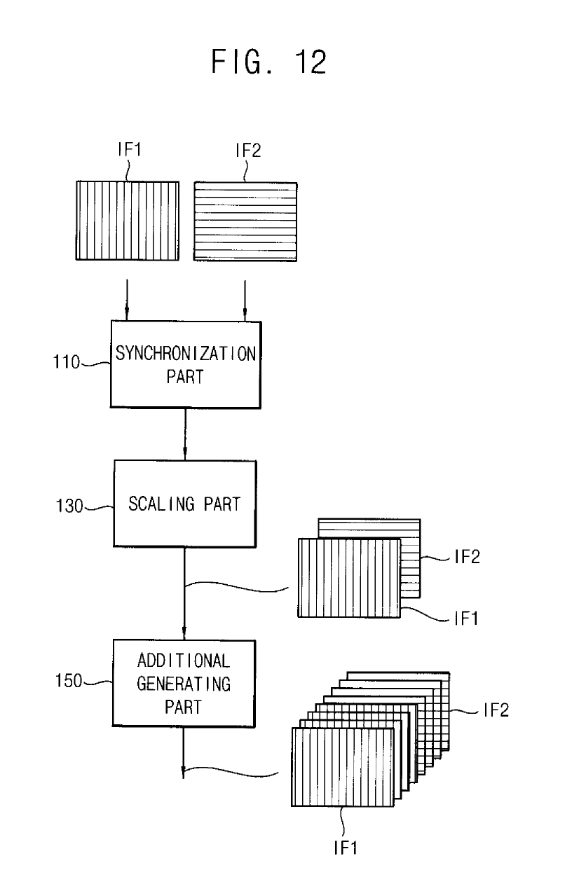

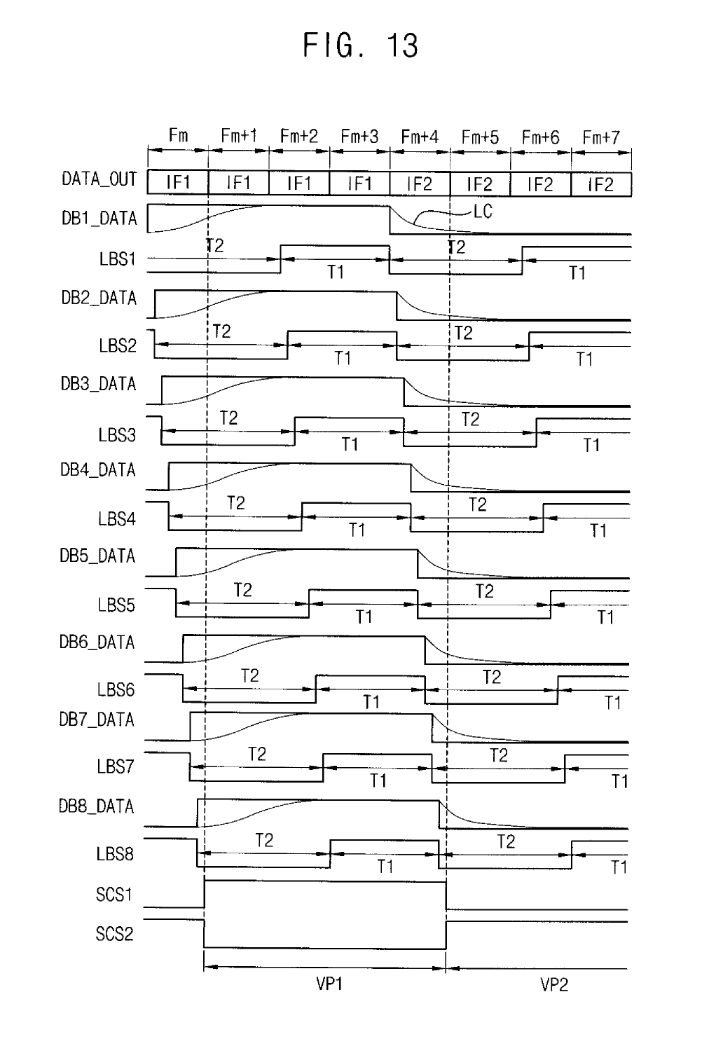

FIG. 12 is a schematic diagram illustrating an exemplary method of processing a 2D image signal of two contents in the display system of FIG. 1. FIG. 13 is a waveform diagram illustrating an exemplary method of displaying the 2D image of two contents in the display system of FIG. 1. As shown in FIG. 13, a first image frame IF1 may be referred to as an image frame of a white grayscale and a second image frame IF2 may be referred to as an image frame of a black grayscale.

Referring to FIGS. 2, 12 and 13, the image processing part 100 receives an image mode signal and the 2D image signal corresponding to a 2D two viewer mode (step S310).

The image processing part 100 receives a first image frame IF1 and a second image frame IF2 through transmission channels different from each other, and outputs a plurality of first image frames IF1 and a plurality of second image frames IF2 (step S330).

For example, the synchronization part 110 receives a first image frame IF1 and a second image frame IF2 through transmission channels different from each other. The image frame IF1 or IF2 has a data size corresponding to a resolution of the display panel 300. The synchronization part 110 outputs the first and second image frame IF1 and IF2 in synchronization with each other.

The scaling part 130 scales each of the first image frame IF1 and the second image frame IF2 into the resolution of the display panel 300. The scaling part 130 sequentially outputs the first image frame IF1 and the second image frame IF2.

The additional generating part 150 repeats the first image frame IF1 and the mage frame IF2 to output four first image frames IF1 and four second image frames IF2, respectively. The additional generating part 150 may output the received image frames IF1 and IF2 into a plurality of image frames using an MEMC mode, respectively.

The timing control part 200 controls the panel driving part 400 and the light source driving part 600 based upon four first image frames IF1 and four second image frames IF2 to display the 2D image of two contents on the display panel 300 (step S350).

Referring to FIG. 13, the timing control part 200 sequentially provides four first image frames IF1 and four second image frames IF2 to the panel driving part 400 DATA_OUT. The panel driving part 400 converts the image data of the image frame into the data signal of the analogue type, and outputs the data signal to the display panel 300 in a progressive scan mode. The panel driving part 400 may be driven with 480 Hz.

Referring to a first display block DB1 of the display panel 300, the panel driving part 400 outputs the data signal of the first image frame during an early period of each of an m-th frame Fm, an (m+1)-th frame Fm+1, an (m+2)-th frame Fm+2 and an (m+3)-th frame Fm+3, and outputs the data signal of the second image frame IF2 during the early period of each of an (m+4)-th frame Fm+4, an (m+5)-th frame Fm+5, an (m+6)-th frame Fm+6 and an (m+7)-th frame Fm+7, as DB1 DATA.

The light source driving part 600 generates a first driving signal LBS1 based upon an LC response time LC, and provides the first driving signal LBS1 to a first light emitting block LB1 corresponding to a first display block DB1. For example, the first light emitting block LB1 provides the light to the first display block DB1 during a first period T1 in which a first or second image is displayed on the first display block DB1, and blocks the light from the first display block DB1 during a second period T2 in which the first and second images are displayed together on the first display block DB1.

Referring to a fifth display block DB5 of the display panel 300, the panel driving part 400 outputs the data signal of the first image frame IF1 during a middle period of each of the m-th, (m+1)-th, (m+2)-th and (m+3)-th frames Fm, Fm+1, Fm+2 and Fm+3, and outputs the data signal of the second image frame IF2 during the middle period of each of the (m+4)-th, (m+5)-th, (m+6)-th and (m+7)-th frames Fm+4, Fm+5, Fm+6 and Fm+7, as DB5_DATA.

The light source driving part 600 generates a fifth driving signal LBS5 based upon the LC response time LC, and provides the fifth driving signal LBS5 to a fifth light emitting block LB5 corresponding to a fifth display block DB5. For example, the fifth light emitting block LB5 provides the light to the fifth display block DB5 during the first period T1 in which the first or second image is display on the fifth display block DB5, and blocks the light from the fifth display block DB5 during the second period T2 in which the first and second images are displayed together on the fifth display block DB5.

Referring to an eighth display block DB8 of the display panel 300, the panel driving part 400 outputs the data signal of the first image frame IF1 for the left-eye during a latter period of each of the m-th, (m+1)-th, (m+2)-th and (m+3)-th frames Fm, Fm+1, Fm+2 and Fm+3, and outputs the data signal of the second image frame IF2 during the latter period of each of the (m+4)-th, (m+5)-th, (m+6)-th and (m+7)-th frames Fm+4, Fm+5, Fm+6 and Fm+7, as DB8_DATA.

The light source driving part 600 generates an eighth driving signal LBS8 based upon the LC response time LC, and provides the eighth driving signal LBS8 to an eighth light emitting block LB8 corresponding to an eighth display block DB8. For example, the eighth light emitting block LB8 provides the light to the eighth display block DB8 during the first period T1 in which the first image or the second image is display on the eighth display block DB8, and blocks the light from the eighth display block DB8 during the second period T2 in which the first and second images are displayed together on the eighth display block DB8. As described above, the display panel 300 and the light source part 500 are driven to display the 2D image of two contents.

The shutter glasses part 700 drives a first shutter glasses and a second shutter glasses based upon a control of the timing control part 200 according to the 2D two viewer mode (step S370).

According to the 2D image mode, a control signal of controlling the shutter glasses part 700 includes a first shutter control signal SCSI opening or closing together left and right shutters of the first shutter glasses and a second shutter control signal SCS2 opening or closing together left and right shutters of the second shutter glasses.

The first shutter control signal SCS1 controls the left and right shutters of the first shutter glasses to be open during a first view period VP1 including a plurality of first periods T1 in which the light emitting blocks LB1, LB2, . . . , LB8 respectively provides the light to the display blocks DB1, DB2, . . . , DB8 displaying a first image, and to be closed during a second view period VP2 including a plurality of first periods T1 in which the light emitting blocks LB1, LB2, . . . , LB8 respectively provides the light to the display blocks DB1, DB2, . . . , DB8 displaying a second image.

The second shutter control signal SCS2 controls the left and right shutters of the second shutter glasses to be open during the second view period VP2 including a plurality of first periods T1 in which the light emitting blocks LB1, LB2, . . . , LB8 respectively provides the light to the display blocks DB1, DB2, . . . , DB8 displaying the second image, and to be closed during the first view period VP1 including a plurality of first periods T1 in which the light emitting blocks LB1, LB2, . . . , LB8 respectively provides the light to the display blocks DB1, DB2, . . . , DB8 displaying the first image.

As described above, two viewers may view the 2D images different from each other.

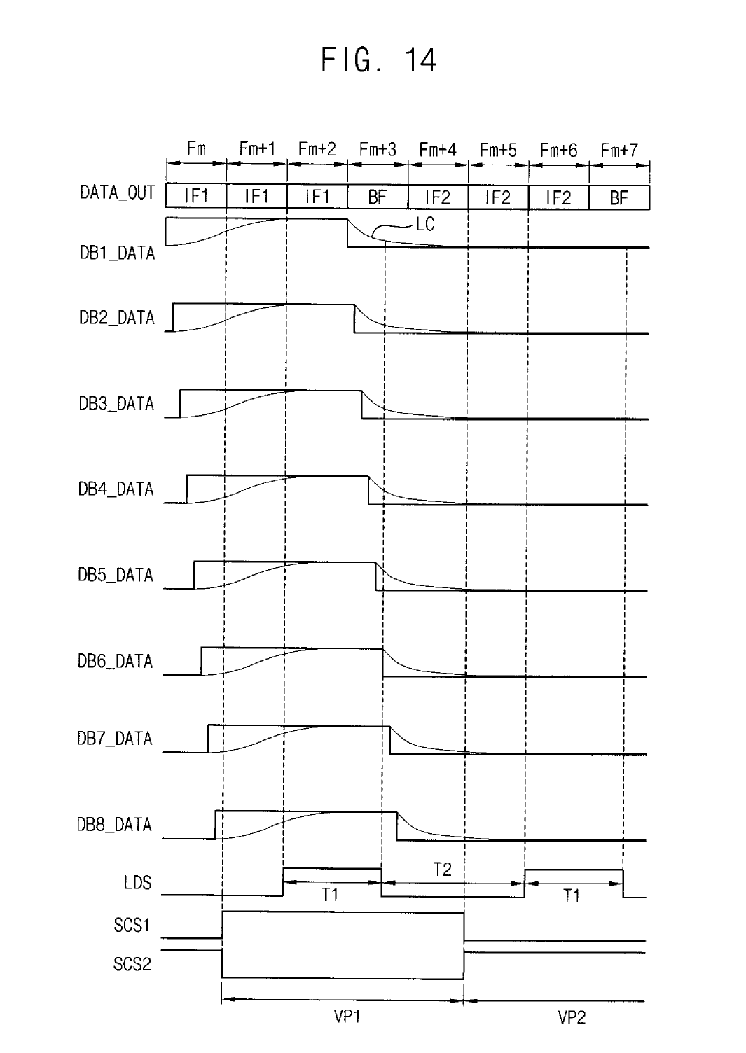

FIG. 14 is a waveform diagram illustrating another exemplary method of displaying the 2D image of two contents in the display system of FIG. 1. As shown in FIG. 14, a first image frame IF1 may be referred to as an image frame of a white grayscale and a second image frame IF2 may be referred to as an image frame of a black grayscale.

Referring to FIGS. 2, 12 and 14, the image processing part 100 receives an image mode signal and a 2D image signal corresponding to a 2D two viewer mode (step S310).

The image processing part 100 receives a first image frame IF1 and a second image frame IF2 through transmission channels different from each other, and outputs a plurality of first image frames IF1 and a plurality of second image frames IF2 (step S330).

The timing control part 200 controls the panel driving part 400 and the light source driving part 600 based upon four first image frames IF1 and four second image frames IF2 to display the 2D image of two contents on the display panel 300 (step S350).

Referring to FIG. 14, the timing control part 200 inserts a black image frame between the first and second image frames IF1 and IF2 to decrease a crosstalk of the first and second images.

The timing control part 200 sequentially outputs three first image frames IF1, the block image frame BF, three second image frames IF2 and the black image frame BF to the panel driving part 400 DATA_OUT. The panel driving part 400 converts the image data of the image frame into the data signal of the analogue type, and outputs the data signal to the display panel 300 in a progressive scan mode. The panel driving part 400 may be driven with 480 Hz.

Referring to a first display block DB1 of the display panel 300, the panel driving part 400 outputs the data signal of the first image frame IF1 during an early period of each of an m-th frame Fm, an (m+1)-th frame Fm+1, an (m+2)-th frame Fm+2, outputs the data signal of the black image frame BF during the early period of an (m+3)-th frame Fm+3, outputs the data signal of the second image frame IF2 during the early period of each of an (m+4)-th frame Fm+4, an (m+5)-th frame Fm+5 and an (m+6)-th frame Fm+6, and outputs the data signal of the black image frame BF during the early period of an (m+7)-th frame

Fm+7, as DB1_DATA.

The light source driving part 600 generates a light source driving signal LDS based upon an LC response time LC, and provides the light source driving signal LDS to a first light emitting block LB1 corresponding to the light source part 500. For example, the light source driving signal LDS is provided to all light emitting blocks LB1, . . . , LBn so that the light emitting blocks LB1, . . . , LBn are entirely turned on or off in synchronization with the light source driving signal LDS.

For example, the light source part 500 entirely provides the light to the display panel 300 during a first period T1 in which the first or second image is displayed on the display panel 300, and the light source part 500 entirely blocks the light from the display panel 300 during a second period T2 in which the first or second image and a black image are displayed together on the display panel 300. As described above, the display panel 300 and the light source part 500 are driven to display the 2D image of two contents. However, not shown in FIG. 14, the light source driving part 600 may drive the light emitting blocks LB1, LB2, . . . , LB8) using substantially same scanning method as described the above exemplary embodiments.

The shutter glasses part 700 drives a first shutter glasses and a second shutter glasses based upon a control of the timing control part 200 according to the 2D two viewer mode (step S370).

According to the 2D image mode, a control signal of controlling the shutter glasses part 700 includes a first shutter control signal SCSI opening or closing together left and right shutters of the first shutter glasses and a second shutter control signal SCS2 opening or closing together left and right shutters of the second shutter glasses.

The first shutter control signal SCSI controls the left and right shutters of the first shutter glasses to be open during a first view period VP1 including a plurality of first periods T1 in which the light emitting blocks LB1, LB2, . . . , LB8 respectively provides the light to the display blocks DB1, DB2, . . . , DB8 displaying a first image, and to be closed during a second view period VP2 including a plurality of first periods T1 in which the light emitting blocks LB1, LB2, . . . , LB8 respectively provides the light to the display blocks DB1, DB2, . . . , DB8 displaying a second image.

The second shutter control signal SCS2 controls the left and right shutters of the second shutter glasses to be open during the second view period VP2 including a plurality of first periods T1 in which the light emitting blocks LB1, LB2, . . . , LB8 respectively provides the light to the display blocks DB1, DB2, . . . , DB8 displaying the second image, and to be closed during the first view period VP1 including a plurality of first periods T1 in which the light emitting blocks LB1, LB2, . . . , LB8 respectively provides the light to the display blocks DB1, DB2, . . . , DB8 displaying the first image.

As described above, two viewers may view the 2D images different from each other.

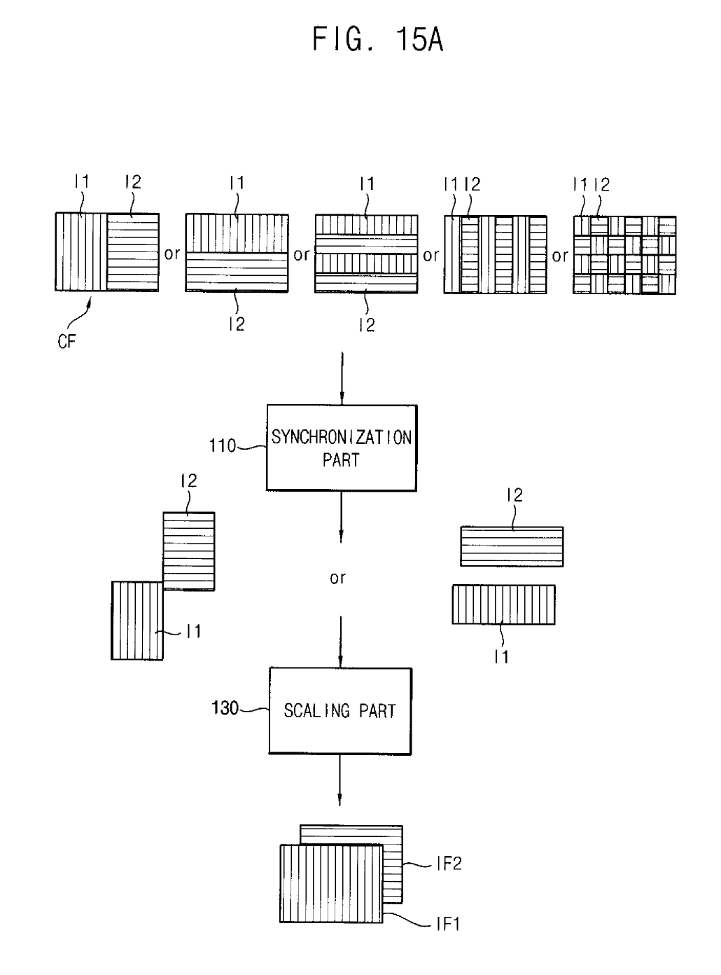

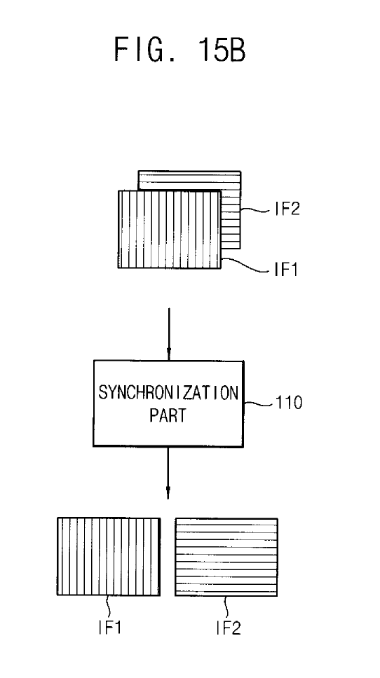

FIGS. 15A and 15B are schematic diagrams illustrating an exemplary method of processing the 2D image signal of two contents received in various modes in the display system of FIG. 1.

Referring to FIGS. 1 and 15A, the synchronization part 110 receives a compression image frame CF through a transmission channel. The compression image frame CF includes a first image signal I1 and a second image signal I2, each of which is compressed by ½. The compression image frame CF may be compressed by a side-by-side mode, a top-bottom mode, a horizontal interleave mode, a vertical interleave mode, a checkerboard mode, etc.

The synchronization part 110 divides the compression image frame into the first and second image signals I1 and I2, and outputs the first and second image signals I1 and I2 in synchronization with each other.

The scaling part 130 scales the first and second image signals I1 and I2 into a first image frame IF1 and a second frame IF2 corresponding to a resolution of the display panel 300, respectively. The scaling part 130 sequentially outputs the first and second image frame IF1 and IF2.

The additional generating part 150 repeats the first and second image frames IF1 and IF2 to output a plurality of first image frames IF1 and a plurality of second image frames IF2. The additional generating part 150 may output the received image frames IF1 and IF2 into a plurality of image frames using an MEMC mode, respectively.

A method of driving the timing control part 200, the panel driving part 400, the light source driving part 600 and the shutter glasses part 700 may be substantially the same as the method previously described referring to FIGS. 12 to 14 and any further repetitive explanation concerning the above elements will be omitted.

Referring to FIGS. 1 and 15B, the synchronization part 110 receives a first image signal IF1 and a second image signal IF2 of two contents through the same transmission channel. Each of the first and second image signals IF1 and IF2 may have a data size corresponding to the resolution of the display panel 300. The synchronization part 110 outputs the first and second image signals IF1 and IF2 in synchronization with each other. The scaling part 130 scales the first and second image signals IF1 and IF2, and sequentially outputs first and second image frames IF1 and IF2. The additional generating part 150 repeats the first and second image frames IF1 and IF2 to output a plurality of first image frames IF1 and a plurality of second image frames IF2. The additional generating part 150 may output the received image frames IF1 and IF2 into a plurality of image frames using an MEMC mode, respectively.

A method of driving the timing control part 200, the panel driving part 400, the light source driving part 600 and the shutter glasses part 700 may be substantially the same as the method previously described referring to FIGS. 12 to 14 and any further repetitive explanation concerning the above elements will be omitted.

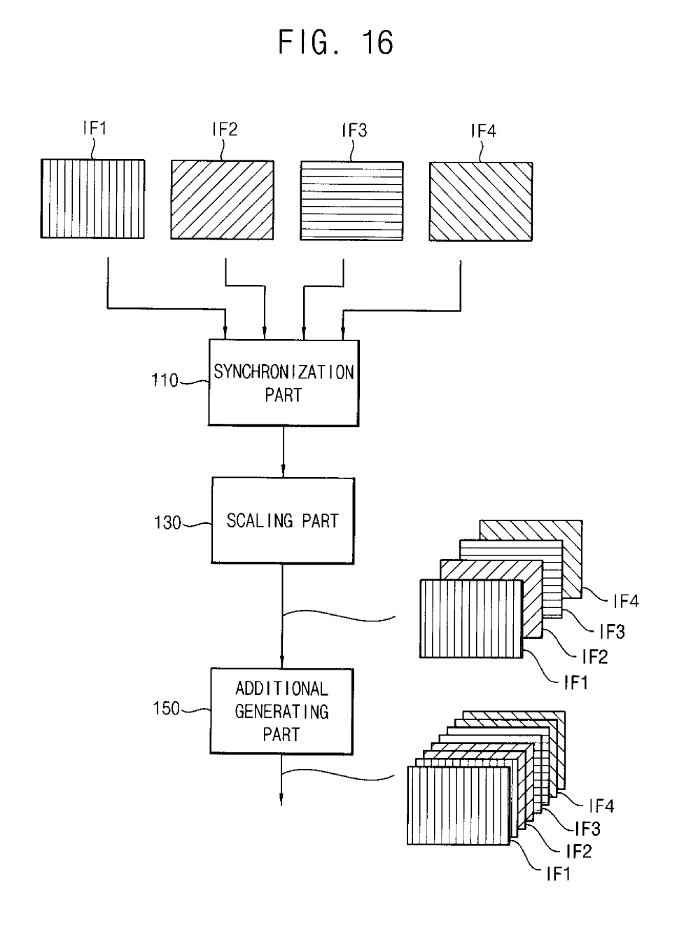

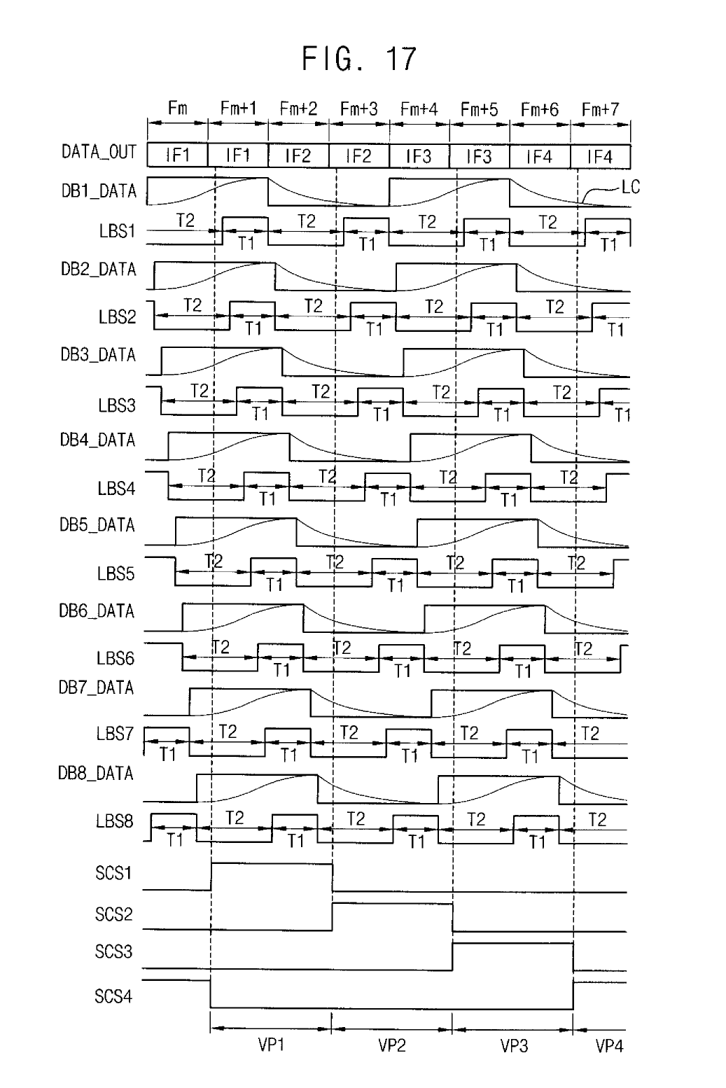

FIG. 16 is a schematic diagram illustrating an exemplary method of processing a 2D image signal of four contents in the display system of FIG. 1. FIG. 17 is a waveform diagram illustrating an exemplary method of displaying the 2D image of four contents in the display system of FIG. 1. As shown in FIG. 17, a first image frame IF1 may be referred to as an image frame of a white grayscale and a second image frame IF2 may be referred to as an image frame of a black grayscale.

Referring to FIGS. 2, 16 and 17, the image processing part 100 receives an image mode signal and a 2D image signal corresponding to a 2D four viewer mode (step S410).

The image processing part 100 receives a first image frame IF1, a second image frame IF2, a third image frame IF3 and a fourth image frame IF4 through transmission channels different from each other, and outputs a plurality of first image frames IF1, a plurality of second image frames IF2, a plurality of third image frames IF3 and a plurality of fourth images frame IF4 (step S430).

For example, the synchronization part 110 receives the first image frame IF1, the second image frame IF2, the third image frame IF3 and the fourth image frame IF4 through transmission channels different from each other. Each of the first to fourth image frames has a data size corresponding to a resolution of the display panel 300. The synchronization part 110 outputs the first, second, third and fourth image frames IF1, IF2, IF3 and IF4 in synchronization with each other.

The scaling part 130 scales the first, second, third and fourth image frames IF1, IF2, IF3 and IF4 and sequentially outputs the first, second, third and fourth image frames IF1, IF2, IF3 and IF4, respectively.

The additional generating part 150 repeats outputs the first, second, third and fourth image frames IF1, IF2, IF3 and IF4 and outputs two first image frames IF1, two second image frames IF2, two third image frames IF3 and two forth image frame IF4, respectively. The additional generating part 150 may output the received image frames into a plurality of image frames using an MEMC mode, respectively.

The timing control part 200 controls the panel driving part 400 and the light source driving part 600 based upon two first image frames IF1, two second image frames IF2, two third image frames IF3 and two forth image frame IF4 to display the 2D image of four contents on the display panel 300 (step S450).

Referring to FIG. 17, the timing control part 200 sequentially outputs two first image frames IF1, two image frames IF2, two image frames IF3 and two forth image frame IF4 (DATA_OUT). The panel driving part 400 converts the image data of the image frame into the data signal of the analogue type, and outputs the data signal to the display panel 300 in a progressive scan mode. The panel driving part 400 may be driven with 480 Hz.

Referring to a first display block DB1 of the display panel 300, the panel driving part 400 outputs the data signal of the first image frame IF1 during an early period of each of an m-th frame Fm and an (m+1)-th frame Fm+1, outputs the data signal of the second image frame IF2 during the early period of an (m+2)-th frame Fm+2 and an (m+3)-th frame Fm+3, outputs the data signal of the third image frame IF3 during the early period of each of an (m+4)-th frame Fm+4 and an (m+5)-th frame Fm+5, and outputs the data signal of the fourth image frame IF4 during the early period of an (m+6)-th frame Fm+6 and an (m+7)-th frame Fm+7, DB1_DATA.

The light source driving part 600 generates a first driving signal LBS1 based upon an LC response time LC, and provides the first driving signal LBS1 to a first light emitting block LB1 corresponding to a first display block DB1. For example, the first light emitting block LB1 provides the light to the first display block DB1 during a first period T1 in which first, second, third or fourth image is displayed on the first display block DB1, and blocks the light from the first display block DB1 during a second period T2 in which at least two of the first, second, third and fourth images are displayed together on the first display block DB1.

Referring to a fifth display block DB5 of the display panel 300, the panel driving part 400 outputs the data signal of the first image frame IF1 during an middle period of each of the m-th and (m+1)-th frames Fm and Fm+1, outputs the data signal of the second image frame IF2 during the middle period of the (m+2)-th and (m+3)-th frames Fm+2 and Fm+3, outputs the data signal of the third image frame IF3 during the middle period of each of the (m+4)-th and (m+5)-th frames Fm+4 and Fm+5, and outputs the data signal of the fourth image frame IF4 during the middle period of the (m+6)-th and (m+7)-th frames Fm+6 and Fm+7, as DB5_DATA.

The light source driving part 600 generates a fifth driving signal LBS5 based upon an LC response time LC, and provides the fifth driving signal LBS5 to a fifth light emitting block LB5 corresponding to a fifth display block DB5. For example, the fifth light emitting block LB5 provides the light to the fifth display block DB5 during the first period T1 in which first, second, third or fourth image is displayed on the fifth display block DB5, and blocks the light from the fifth display block DB5 during the second period T2 in which at least two of the first, second, third and fourth images are displayed together on the fifth display block DB5.

Referring to an eighth display block DB8 of the display panel 300, the panel driving part 400 outputs the data signal of the first image frame IF1 during an latter period of each of the m-th and (m+1)-th frames Fm and Fm+1, outputs the data signal of the second image frame IF2 during the latter period of the (m+2)-th and (m+3)-th frames Fm+2 and Fm+3, outputs the data signal of the third image frame IF3 during the latter period of each of the (m+4)-th and (m+5)-th frames Fm+4 and Fm+5, and outputs the data signal of the fourth image frame IF4 during the latter period of the (m+6)-th and (m+7)-th frames Fm+6 and Fm+7, as DB8_DATA.

The light source driving part 600 generates an eighth driving signal LBS5 based upon the LC response time LC, and provides the eighth driving signal LBS8 to an eighth light emitting block LB8 corresponding to an eighth display block DB8. For example, the eighth light emitting block LB8 provides the light to the eighth display block DB8 during the first period T1 in which first, second, third or fourth image is displayed on the eighth display block DB8, and blocks the light from the eighth display block DB8 during the second period T2 in which at least two of the first, second, third and fourth images are displayed together on the eighth display block DB8.

The shutter glasses part 700 drives a first shutter glasses, a second shutter glasses, a third shutter glasses and a fourth shutter glasses based upon a control of the timing control part 200 according to the 2D four viewer mode (step S470).

A control signal of controlling the shutter glasses part 700 includes a first shutter control signal SCS1 opening or closing together left and right shutters of the first shutter glasses, a second shutter control signal SCS2 opening or closing together left and right shutters of the second shutter glasses, a third shutter control signal SCS3 opening or closing together left and right shutters of the third shutter glasses, and a forth second shutter control signal SCS4 opening or closing together left and right shutters of the fourth shutter glasses.

The first shutter control signal SCS1 controls the shutters of the first shutter glasses to be open during a first view period VP1 including a plurality of first periods T1 in which the light emitting blocks LB1, LB2, . . . , LB8 respectively provides the light to the display blocks DB1, DB2, . . . , DB8 displaying a first image, and to be closed during second, third and fourth view periods VP2, VP3 and VP4 including a plurality of first periods T1 in which the light emitting blocks LB1, LB2, . . . , LB8 respectively provides the light to the display blocks DB1, DB2, . . . , DB8 displaying second, third and fourth images.

The second shutter control signal SCS2 controls the shutters of the second shutter glasses to be open during the second view period VP2 including a plurality of first periods T1 in which the light emitting blocks LB1, LB2, . . . , LB8 respectively provides the light to the display blocks DB1, DB2, . . . , DB8 displaying the second image, and to be closed during first, third and fourth view periods VP1, VP3 and VP4 including a plurality of first periods T1 in which the light emitting blocks LB1, LB2, . . . , LB8 respectively provides the light to the display blocks DB1, DB2, . . . , DB8 displaying first, third and fourth images.

The third shutter control signal SCS3 controls the shutters of the third shutter glasses to be open during the third view period VP3 including a plurality of first periods T1 in which the light emitting blocks LB1, LB2, . . . , LB8 respectively provides the light to the display blocks DB1, DB2, . . . , DB8 displaying the third image, and to be closed during first, second and fourth view periods VP1, VP2 and VP4 including a plurality of first periods T1 in which the light emitting blocks LB1, LB2, . . . , LB8 respectively provides the light to the display blocks DB1, DB2, . . . , DB8 displaying first, second and fourth images.

The fourth shutter control signal SCS4 controls the shutters of the fourth shutter glasses to be open during the fourth view period VP4 including a plurality of first periods T1 in which the light emitting blocks LB1, LB2, . . . , LB8 respectively provides the light to the display blocks DB1, DB2, . . . , DB8 displaying the fourth image, and to be closed during first, second and third view periods VP1, VP2 and VP3 including a plurality of first periods T1 in which the light emitting blocks LB1, LB2, . . . , LB8 respectively provides the light to the display blocks DB1, DB2, . . . , DB8 displaying first, second and third images.

As described above, four viewers may view the 2D images different from each other.

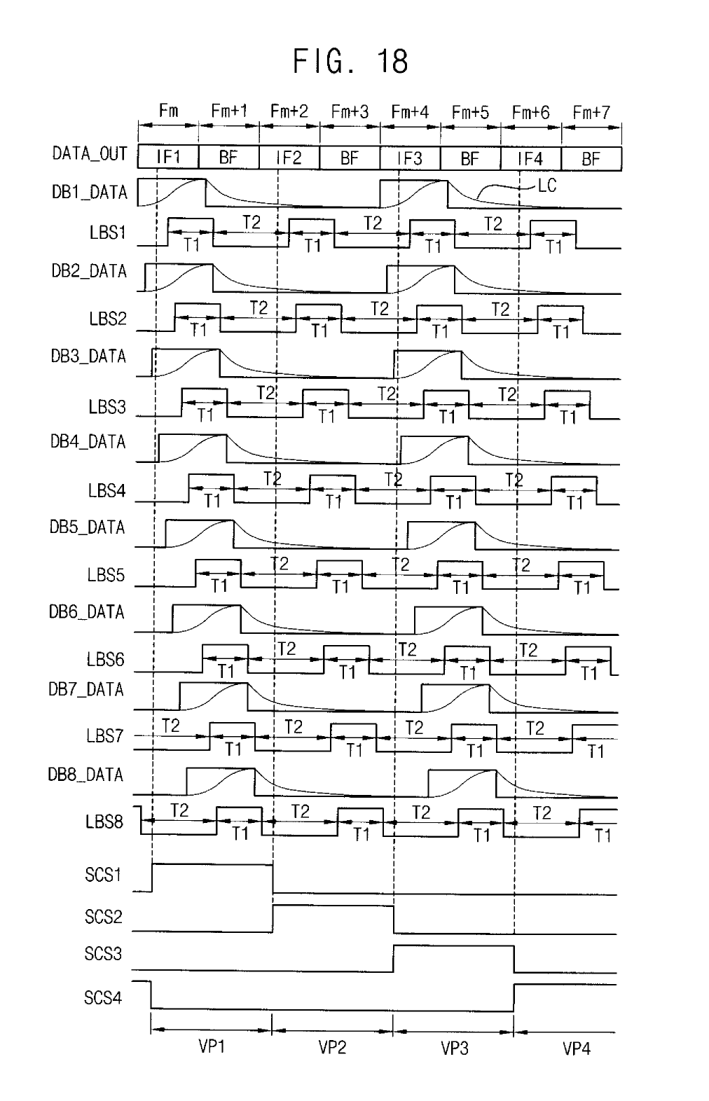

FIG. 18 is a waveform diagram illustrating another exemplary method of displaying the 2D image of four contents in the display system of FIG. 1.

Referring to FIGS. 2, 16 and 18, the image processing part 100 receives an image mode signal and a 2D image signal corresponding to 2D four viewer mode (step S410).

The image processing part 100 receives a first image frame IF1, a second image frame IF2, a third image frame IF3 and a fourth image frame IF4 through transmission channels different from each other, and outputs a plurality of first image frames IF1, a plurality of second image frames IF2, a plurality of third image frames IF3 and a plurality of fourth images frame IF4 (step S430).

The timing control part 200 controls the panel driving part 400 and the light source driving part 600 based upon two first image frames IF1, two second image frames IF2, two third image frames IF3 and two forth image frame IF4 to display the 2D image of four contents on the display panel 300 (step S450).

Referring to FIG. 18, the timing control part 200 inserts a black image frame between the images adjacent to each other to decrease a crosstalk between the images adjacent to each other.

The timing control part 200 sequentially provides a first image frame IF1, the black image frame BF, a second image frame IF2, the black image frame BF, a third image frame IF3, the black image frame BF, a fourth image frame IF4, the black image frame BF to the panel driving part 400 DATA_OUT. The panel driving part 400 converts the image data of the image frame into the data signal of the analogue type, and outputs the data signal to the display panel 300 in a progressive scan mode. The panel driving part 400 may be driven with 480 Hz.

Referring to a first display block DB1 of the display panel 300, the panel driving part 400 outputs the data signal of the first image frame IF1 during an early period of an m-th frame Fm, outputs the data signal of the black image frame BF during the early period of an (m+1)-th frame Fm+1, outputs the data signal of the second image frame IF2 during the early period of an (m+2)-th frame Fm+2, outputs the data signal of the black image frame BF during the early period of an (m+3)-th frame Fm+3, outputs the data signal of the third image frame IF3 during the early period of an (m+4)-th frame Fm+4, outputs the data signal of the black image frame BF during the early period of an (m+5)-th frame Fm+5, outputs the data signal of the fourth image frame IF4 during the early period of an (m+6)-th frame Fm+6, and outputs the data signal of the black image frame BF during the early period of an (m+7)-th frame Fm+7, as DB1_DATA.

The light source driving part 600 generates a first driving signal LBS1 based upon an LC response time LC, and provides the first driving signal LBS1 to a first light emitting block LB1 corresponding to a first display block DB1. For example, the first light emitting block LB1 provides the light to the first display block DB1 during a first period T1 in which first, second, third or fourth image is displayed on the first display block DB1, and blocks the light from the first display block DB1 during a second period T2 in which at least two of the first, second, third and fourth images are displayed together on the first display block DB1. As described above, the display panel 300 and the light source part 500 are driven to display the 2D images of four contents.

A control signal of controlling the shutter glasses part 700 includes a first shutter control signal SCS1 opening or closing together left and right shutters of the first shutter glasses, a second shutter control signal SCS2 opening or closing together left and right shutters of the second shutter glasses, a third shutter control signal SCS3 opening or closing together left and right shutters of the third shutter glasses and a forth second shutter control signal SCS4 opening or closing together left and right shutters of the fourth shutter glasses. The first to fourth shutter control signals SCS1, SCS2, SCS3 and SCS4 are driven as may be substantially the same as described referring to FIG. 17.

Each of first to fourth shutter control signals SCS1, SCS2, SCS3 and SCS4 according to the present exemplary embodiment may have a delay difference with respect to those described in FIG. 17 due to the black image frame BF.

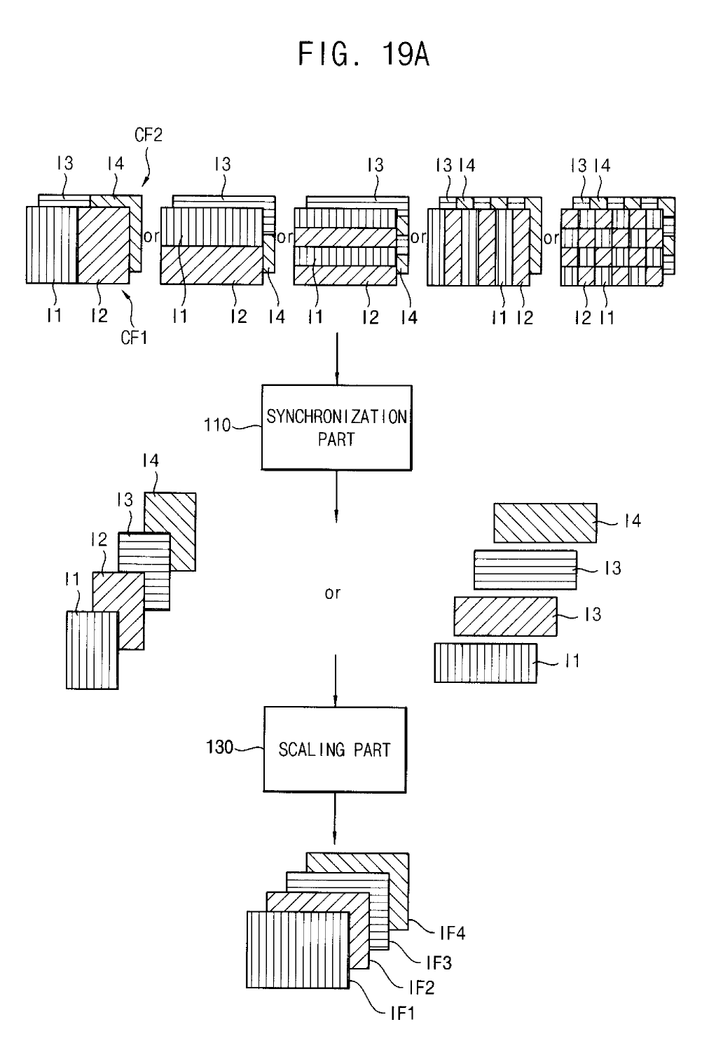

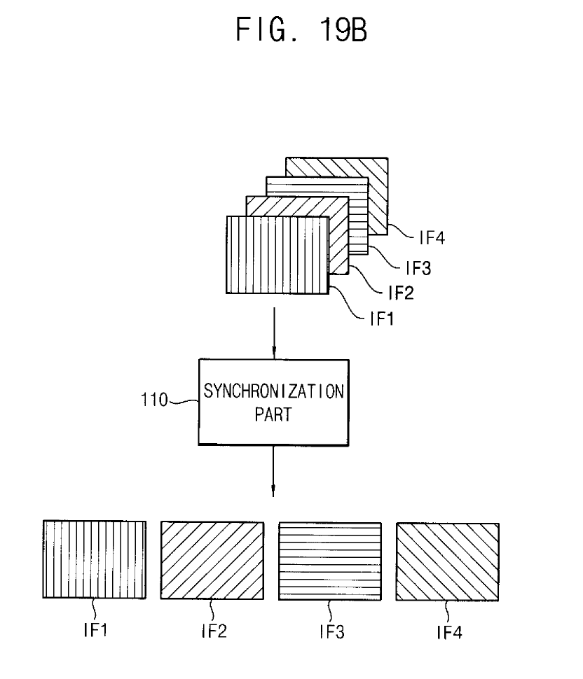

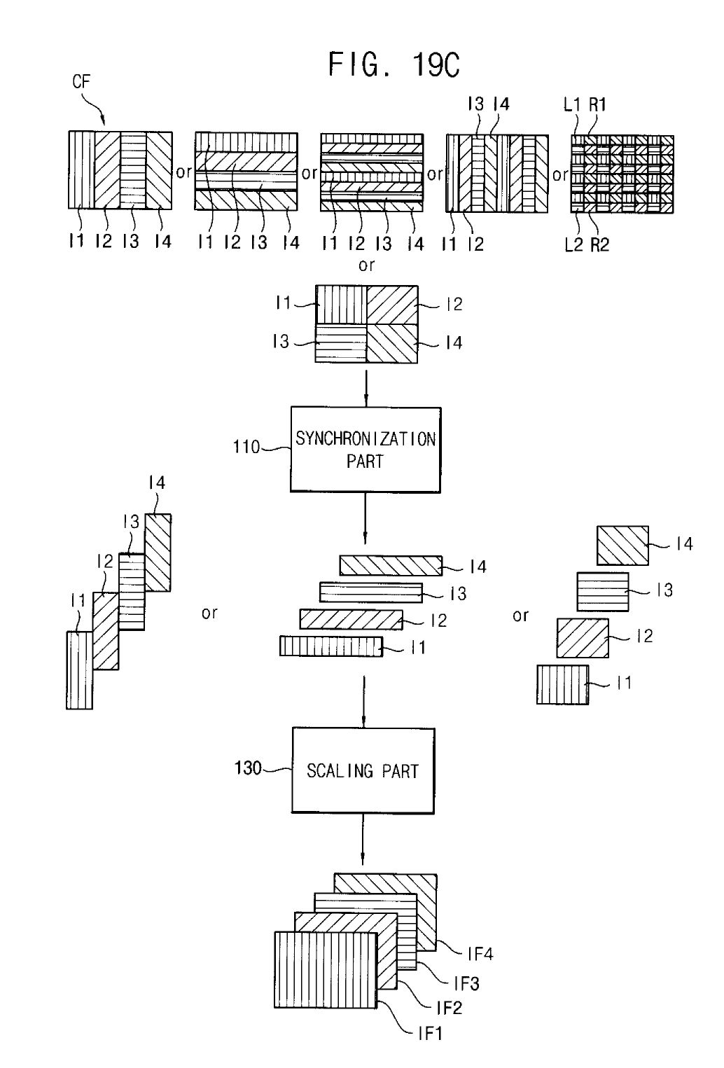

FIGS. 19A, 19B and 19C are schematic diagrams illustrating a method of processing the 2D image signal of four contents received in various modes in the display system of FIG. 1.

Referring to FIGS. 1 and 19A, the synchronization part 110 receives a first compression image frame CF1 and a second compression image frame CF2 through the same transmission channel. The first compression image frame CF1 includes a first image signal I1 and a second image signal I2, each of which is compressed by ½. The second compression image frame CF2 includes a third image signal I3 and a fourth image signal I4, each of which is compressed by ½. The first and second compression image frames CF1 and CF2 may be compressed by a side-by-side mode, a top-bottom mode, a horizontal interleave mode, a vertical interleave mode, a checkerboard mode, etc.

The synchronization part 110 divides the first and second compression image frames CF1 and CF2 into a first image signal I1, a second image signal I2, a third image signal I3 and a fourth image signal I4, and outputs the first to fourth image signals I1, I2, I3 and I4 in synchronization with each other.

The scaling part 130 scales the first to fourth image signals I1, I2, I3 and I4 into a first image frame IF1, a second image frame IF2, a third image frame IF3 and a fourth image frame IF4 corresponding to a resolution of the display panel 300, respectively. The scaling part 130 sequentially outputs the first to fourth image frames IF1, IF2, IF3 and IF4.

The additional generating part 150 repeats the first to fourth image frames IF1, IF2, IF3 and IF4 to output a plurality of first image frames IF1 and IF1, a plurality of second image frames IF2 and IF2, a plurality of third image frames IF3 and IF3 and a plurality of fourth image frames IF4 and IF4. The additional generating part 150 may output the received image frames into a plurality of image frames using an MEMC mode, respectively.

A method of driving the timing control part 200, the panel driving part 400, the light source driving part 600 and the shutter glasses part 700 may be substantially the same as the method previously described referring to FIGS. 2 and 16 to 18 and any further repetitive explanation concerning the above elements will be omitted.

Referring to FIGS. 1 and 19B, the synchronization part 110 receives a first image frame IF1, a second image frame IF2, a third image frame IF3 and a fourth image frame IF4 through the same transmission channel. The synchronization part 110 outputs the first to fourth image frames IF1, IF2, IF3 and IF4 in synchronization with each other to the scaling part 130. The scaling part 130 scales the first to fourth image frames IF1, IF2, IF3 and IF4 and sequentially outputs the first to fourth image frames IF1, IF2, IF3 and IF4 to the additional generating part 150. The additional generating part 150 repeats the first to fourth image frames IF1, IF2, IF3 and IF4 to output a plurality of first image frames IF1 and IF1, a plurality of second image frames IF2 and IF2, a plurality of third image frames IF3 and IF3 and a plurality of fourth image frames IF4 and IF4. The additional generating part 150 may output the received image frames into a plurality of image frames using an MEMC mode, respectively.

A method of driving the timing control part 200, the panel driving part 400, the light source driving part 600 and the shutter glasses part 700 may be substantially the same as the previously described referring to FIGS. 2 and 16 to 18 and any further repetitive explanation concerning the above elements will be omitted.

Referring to FIGS. 1 and 11C, the synchronization part 110 receives a compression image frame CF through a same transmission channel. The compression image frame CF includes a first image signal I1, a second image signal I2, a third image signal I3 and a fourth image signal I4, each of which is compressed by ¼. The first compression image frame CF may be compressed by a side-by-side mode, a top-bottom mode, a horizontal interleave mode, a vertical interleave mode, a checkerboard mode, etc.

The synchronization part 110 divides the first and second compression image frames CF1 and CF2 into a first image signal I1, a second image signal I2, a third image signal I3 and a fourth image signal I4, and outputs the first to fourth image signals I1, I2, I3 and I4 in synchronization with each other.

The scaling part 130 and the additional generating part 150 sequentially outputs a plurality of first image frames IF1 and IF1, a plurality of second image frames IF2 and IF2, a plurality of third image frames IF3 and IF3 and a plurality of fourth image frames IF4 and IF4, using the first to fourth image signals Il, I2, I3 and I4.

A method of driving the timing control part 200, the panel driving part 400, the light source driving part 600 and the shutter glasses part 700 may be substantially the same as the method previously described referring to FIGS. 2 and 16 to 18 and any further repetitive explanation concerning the above elements will be omitted.

According to the exemplary embodiments of the present invention, the display system may display the 3D or the 2D image corresponding to a plurality of contents according to the selected image mode by the user.

Although a few exemplary embodiments of the present invention have been described, those skilled in the art will readily appreciate that many modifications are possible in the exemplary embodiments. Accordingly, the disclosed exemplary embodiments and all such modifications are intended to be included within the scope of the following claims.

What is claimed is:

1. A display system comprising:
a display panel configured to display an image;
a panel driving part configured to provide a data signal to the display panel;
an image processing part comprising:
a synchronization part configured to synchronize a plurality of image signals respectively corresponding to a plurality of contents with each other,
a scaling part configured to respectively scale the image signals into a plurality of image frames having a resolution of the display panel and to sequentially output the image frames, and
an additional generating part configured to output the image frames respectively corresponding to the image frames received from the scaling part;
a timing control part configured to provide to the panel driving part the image frames respectively corresponding to the contents; and
a light source part configured to generate light and to provide the light to the display panel.

2. The display system of claim 1, wherein, when a compression image frame is received that has the image signals compressed corresponding to the contents, the synchronization part divides the compression image frame into the image signals and synchronizes the divided image signals with each other.

3. The display system of claim 1, wherein, when the image frames having a resolution of the display panel respectively corresponding to the contents are received, the synchronization part synchronizes the received image frames with each other, and the scaling part sequentially outputs the synchronized image frames.

4. The display system of claim 1, wherein the light source part includes a plurality of light emitting blocks arranged in an image scanning direction of the display panel, and each of the light emitting blocks provides the light to a display block of the display panel corresponding to the light emitting block during a first period in which one image is displayed on the display block, and blocks the light from the display block during a second period in which images different from each other are displayed together on the display block.

5. The display system of claim 1, wherein the timing control part inserts a black image frame between a first image frame corresponding to a first contents and a second image frame corresponding to a second contents, and provides the first image frame, the black image frame and the second image frame to the panel driving part.

6. The display system of claim 5, wherein, when an image signal for a left-eye and an image signal for a right-eye corresponding to one contents are received, the image processing part outputs four image frames for the left-eye and four image frames for the right-eye corresponding to one contents to the timing control part.

7. The display system of claim 6, wherein the timing control part sequentially outputs four image frames for the left-eye and four image frames for the right-eye to the panel driving part.

8. The display system of claim 6, wherein the timing control part sequentially outputs three image frames for the left-eye, the black image frame, three image frames for the right-eye and the black image frame to the panel driving part.

9. The display system of claim 5, wherein, when a first image signal for a left-eye, a first image signal for a right-eye, a second image signal for the left-eye and a second image signal for the right-eye corresponding to two contents are received, the image processing part outputs two first image frames for the left-eye, two first image frames for the right-eye, two second image frames for the left-eye, two second image frames for the right-eye corresponding to two contents to the timing control part.

10. The display system of claim 9, wherein the timing control part sequentially outputs two first image frames for the left-eye, two first image frames for the right-eye, two second image frames for the left-eye, and two second image frames for the right-eye to the panel driving part.

11. The display system of claim 9, wherein the timing control part sequentially outputs a first image frame for the left-eye, the black image frame, a first image frame for the right-eye, the black image frame, a second image frame for the left-eye, the black image frame, a second image frame for the right-eye, and the black image frame to the panel driving part.

12. The display system of claim 9, further comprising:
a first shutter glasses part, including a first left-eye shutter and a first right-eye shutter, configured to open the first left-eye shutter and to close the first right-eye shutter during a period in which a first image for the left-eye corresponding to the first image frame for the left-eye is displayed on the display panel, and configured to open the first right-eye shutter and to close the first left-eye shutter during a period in which a first image for the right-eye corresponding to the first image frame for the right-eye is displayed on the display panel; and
a second shutter glasses part, including a second left-eye shutter and a second right-eye shutter, configured to open the second left-eye shutter and to close the second right-eye shutter during a period in which a second image for the left-eye corresponding to the second image frame for the left-eye is displayed on the display panel, and configured to open the second right-eye shutter and to close the second left-eye shutter during a period in which a second image for the right-eye corresponding to the second image frame for the right-eye is displayed on the display panel.

13. The display system of claim 5, wherein, when a first image signal and a second image signal corresponding to two contents are received, the image processing part outputs four first image frames and four second image frames corresponding to two contents to the timing control part.

14. The display system of claim 13, wherein the timing control part sequentially outputs four first image frames and four second image frames to the panel driving part.

15. The display system of claim 13, wherein the timing control part sequentially outputs three first image frames, the black image frame, three second image frames and the black image frame to the panel driving part.

16. The display system of claim 13, further comprising:
a first shutter glasses part, including first shutters, configured to open the first shutters during a period in which a first image corresponding to the first image frame is displayed on the display panel, and to close the first shutters during a period in which a second image corresponding to the second image frame is displayed on the display panel; and
a second shutter glasses part, including second shutters, configured to open the second shutters during a period in which the second image is displayed on the display panel, and to close the second shutters during a period in which the first image is displayed on the display panel.

17. The display system of claim 5, wherein, when a first image signal, a second image signal, a third image signal and a four image signal corresponding to four contents are received, the image processing part outputs two first image frames, two second image frames, two third image frames and two fourth image frames corresponding to four contents to the timing control part.

18. The display system of claim 17, wherein the timing control part sequentially outputs two first image frames, two second image frames, two third image frames and two fourth image frames to the panel driving part.

19. The display system of claim 17, wherein the timing control part sequentially outputs a first image frame, the black image frame, a second image frame, the black image, a third image frame, the black image frame, a fourth image frame and the black image frame to the panel driving part.

20. The display system of claim 17, further comprising:
a first shutter glasses part, including first shutters, configured to open the first shutters during a period in which a first image corresponding to the first image frame is displayed on the display panel, and to close the first shutters during a period in which second, third and fourth images respectively corresponding to the second, third and fourth image frames are displayed on the display panel;
a second shutter glasses part, including second shutters, configured to open the second shutters during a period in which the second image corresponding to the second image frame is displayed on the display panel, and to close the second shutters during a period in which the first, third and fourth images respectively corresponding to the first, third and fourth image frames are displayed on the display panel;
a third shutter glasses part including third shutters, configured to open the third shutters during a period in which the third image corresponding to the third image frame is displayed on the display panel, and to close the third shutters during a period in which the first, second and fourth images respectively corresponding to the first, second and fourth image frames are displayed on the display panel; and
a fourth shutter glasses part including fourth shutters, configured to open the fourth shutters during a period in which the fourth image corresponding to the fourth image frame is displayed on the display panel, and to close the fourth shutters during a period in which the first, second and third images respectively corresponding to the first, second and third image frames is displayed on the display panel.
